(19) United States
(12) Patent Application Publication
(10) Pub. No.: US 2023/0228461 A1
(43) Pub. Date: Jul. 20, 2023

(54) CREATING CONVECTIVE THERMAL RECHARGE IN GEOTHERMAL ENERGY SYSTEMS

(71) Applicant: Geothermal Technologies, Inc., Bel Air, MD (US)

(72) Inventors: Bruce D. MARSH, Hunt Valley, MD (US); Saman KARIMI, Baltimore, MD (US); James HOLLIS, Incline Village, NV (US); J. Gary MCDANIEL, Bel Air, MD (US)

(73) Assignee: Geothermal Technologies, Inc., Bel Air, MD (US)

(21) Appl. No.: 17/578,037

(22) Filed: Jan. 18, 2022

(51) Int. Cl. F24T 10/20; F24T 10/30

(52) U.S. Cl. CPC F24T 10/20; F24T 10/30

(57) ABSTRACT

Disclosed herein are system, apparatus, article of manufacture, method and/or computer program product embodiments, and/or combinations and sub-combinations thereof, for stimulating convective thermal recharge in a hot sedimentary aquifer (HSA) used in geothermal energy generation applications. An example system pumps, via an extraction well, heated water from an extraction depth of a hot sedimentary aquifer (HSA) identified based on a convective heat transfer coefficient of the HSA satisfying a threshold convective heat transfer coefficient. The system then extracts, via a power generation unit, heat from the heated water to generate power and transform the heated water into cooled water. Subsequently, the system injects, via an injection well, the cooled water at an injection depth of the HSA. As a result of these operations, the system stimulates a convective flow field within the HSA having a convective heat transfer rate sufficient to provide a convective thermal recharge of the extracted heat.

### BACKGROUND

Geothermal heat is an excellent source of renewable energy as the Earth's temperature naturally increases with depth. Although there are many geothermal energy facilities around the world, these facilities are typically located in places with volcanic activity, which provide a high temperature and are an easily accessible resource for energy harvesting. Unfortunately, these volcanic regions are geographically limited. Hot dry rock is another potential source of geothermal energy, but nearly all projects attempting to harvest heat in this manner have failed. Hot sedimentary aquifers are widespread and represent a new, promising, and very economical source for geothermal energy production.

### BRIEF DESCRIPTION OF THE FIGURES

The accompanying drawings are incorporated herein and form a part of the specification.

FIG. 1 is a schematic diagram of an example geothermal system, according to some embodiments.

FIG. 2 is a schematic diagram of example well pair haying various instrumentation devices, according to some embodiments.

FIG. 3 is a schematic diagram of an example single-vane unit of an example radiator enhanced geothermal system (RAD-EGS), according to some embodiments.

FIG. 4 is a schematic diagram of an example natural enhanced geothermal system (NAT-EGS), according to some embodiments.

FIG. 5A is a schematic diagram of an example thin-bed NAT-EGS, according to some embodiments.

FIG. 5B illustrates the results of an example numerical simulation of an example thin-bed NAT-EGS, according to some embodiments.

FIG. 6 is a schematic diagram of an example natural geothermal system having multiple pairs of extraction and injection wells formed according to a wagon-wheel pattern, according to some embodiments.

FIG. 7 is a flowchart illustrating a process for configuring a geothermal system, according to some embodiments.

FIG. 8 is a flowchart illustrating a process for harvesting heat from a hot sedimentary aquifer (HSA) according to some embodiments.

FIG. 9 illustrates an example computer system for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Fossil fuels (or hydrocarbons) are the primary source of energy for the world today, and they present two major problems. First, fossil fuel resources are not renewable, meaning that there is a finite amount of them on our planet. Second, using fossil fuels produces carbon dioxide (CO₂), the major greenhouse gas and the main driver of the Earth's atmospheric warming. With the ever-increasing population on Earth, the need for newer, renewable and clean sources of energy is more evident than ever before. In contrast to fossil fuels, geothermal energy has the potential to provide a functionally infinite amount of clean energy, with no carbon footprint. And in contrast to other renewable energies, geothermal energy is constantly available and is the best candidate for providing baseload power. The earlier inefficient designs of geothermal plants, for a number of reasons, were not able to provide a worldwide commercial level of energy extraction from this infinite source of energy beneath our feet. The current locations of geothermal plants are geographically biased, and only extract energy almost exclusively in the proximity of volcanic regions from naturally-occurring, geyser-like hydrothermal systems. Thus, while geothermal energy has a massive potential, the share of such energy in the global energy market is minute.

In one example, geothermal energy can have two main applications: direct use (e.g., heat generation); and power generation. However, as described above, geothermal energy extraction is primarily restricted to seismically and volcanically active regions such as in the western United States. Extracting energy from other parts of Earth's continental crust (e.g., seismically non-active regions) can be expensive, non-economic, and short-lived. Some geothermal systems, referred to as enhanced geothermal systems (EGS), generate man-made hydrothermal reservoirs through artificial fracturing methods such as hydraulic fracking. These geothermal systems can be constructed in hot dry rock (HDR) that are commonly found at sufficiently great depths below the surface such that high enough temperatures are encountered. Constructing an EGS in HDR involves drilling into the HDR and creating an artificially made reservoir through fracturing. Fracturing, however, is a complex and expensive engineering task that requires a substantial amount of equipment (e.g., hardware resources, environmental resources, computing resources, etc.) and is ecologically and environmentally damaging.

Artificially-constructed fractured reservoirs can be designed to contain an extensive plexus of fractures through which fluid flow is facilitated horizontally and/or, randomly and without obstruction. Under such geothermal systems, water from an injection well is made to flow to and through the artificially fractured reservoir, where it becomes heated and then is pumped back up to the surface to the energy conversion unit via the extraction well. As such, the thermal energy of the water is transferred from the hot solid rock through thermal conduction. The efficiency of these conventional geothermal systems is limited because the thermal diffusivity of rock is low. As the waters in the subsurface heat up, the associated rock must proportionally cool down, and the time for replacing the lost rock-heat is very long. The longevity of such systems is thus relatively short, less than 10 years after which the water temperature rapidly drops below the economic level.

Additionally, to construct and operate a geothermal energy system that will last for many years, and thus generate economical energy, it is necessary to construct that system in such a way as to enable the thermal recharge of the system. Many geothermal energy projects have failed over the years because the geothermal energy has been extracted at a rate in excess of the system's ability to reheat or recharge and, as a result, the system rapidly cools down due to the low thermal diffusivity of the underground rock. Essentially, the slow rate of heat conduction into the geothermal system from the surrounding rock is insufficient to keep up with the rate of heat extracted from the geothermal system by the geothermal production well(s).

Accordingly, there is a need to design a geothermal system having a sufficient underground heat transfer rate that can keep up with the geothermal energy extraction rate to make the geothermal system viable. In short, the system must be designed in such a way that heat is entering the system as fast, or nearly as fast, as it is being removed, so the system remains hot for a long time. To do so, the geothermal system must be recharged by both conduction and convection; conductive heat flow from the surrounding rock alone is simply not sufficient. However, as stated above, many geothermal systems have failed, or will fail, because there is little or no convective heat flow within the geothermal system. Achieving convective heat flow is, therefore, absolutely necessary for a geothermal energy system to operate efficiently over a sufficient number of years to make the system economically viable.

Provided herein are system, apparatus, device, method, and/or computer program product embodiments, and/or combinations and sub-combinations thereof, for creating convective heat transfer within a geothermal energy system. The geothermal systems disclosed herein utilize underground systems of lateral or horizontal boreholes, and fractures that, together with gravity, pumping power, and/or aquifer pressures and flows, are organized in such a way as to enable, induce, and/or stimulate convective thermal recharge in the geothermal energy systems that are constructed in aquifers that exist within the earth's sedimentary basins. As a result, the geothermal systems disclosed herein illustrate several system designs that demonstrate the ability to provide a viable geothermal power plant that is recharged by both conduction and convection in such a way that heat is entering the geothermal system about as fast, or nearly as fast, as it is being removed.

As stated above, rock by its nature is a very poor conductor of heat due to its low thermal conductivity. In addition, because rock is a solid, there is substantially no possibility of convection within the rock itself Therefore, a different medium than rock is required to create the necessary convective heat transfer. The geothermal systems described herein utilize water, found in underground hot sedimentary aquifers, as the convective heat transfer medium.

In some embodiments, the present disclosure describes techniques for identifying aquifers with sufficient convective heat transfer coefficients, permeabilities, porosities, fracture systems, etc. to allow for convective flow to occur. The present disclosure further describes techniques for creating convective flows within these aquifers.

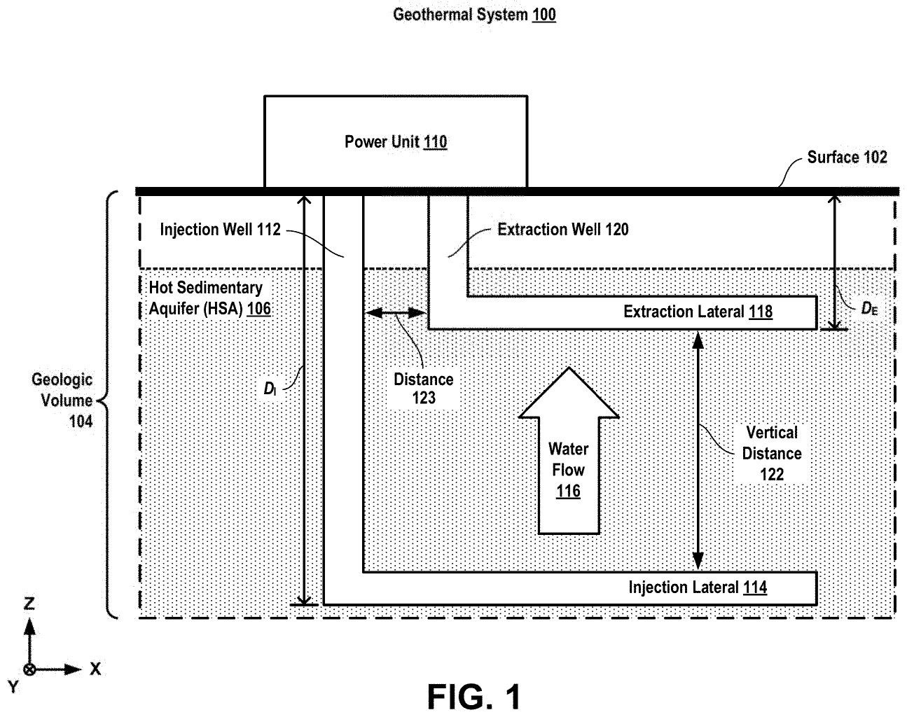

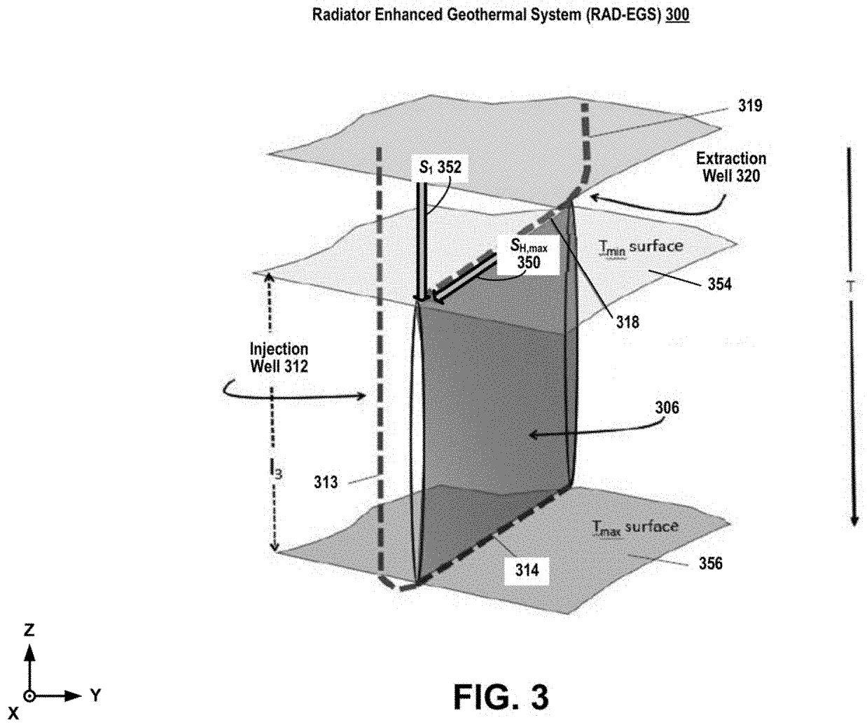

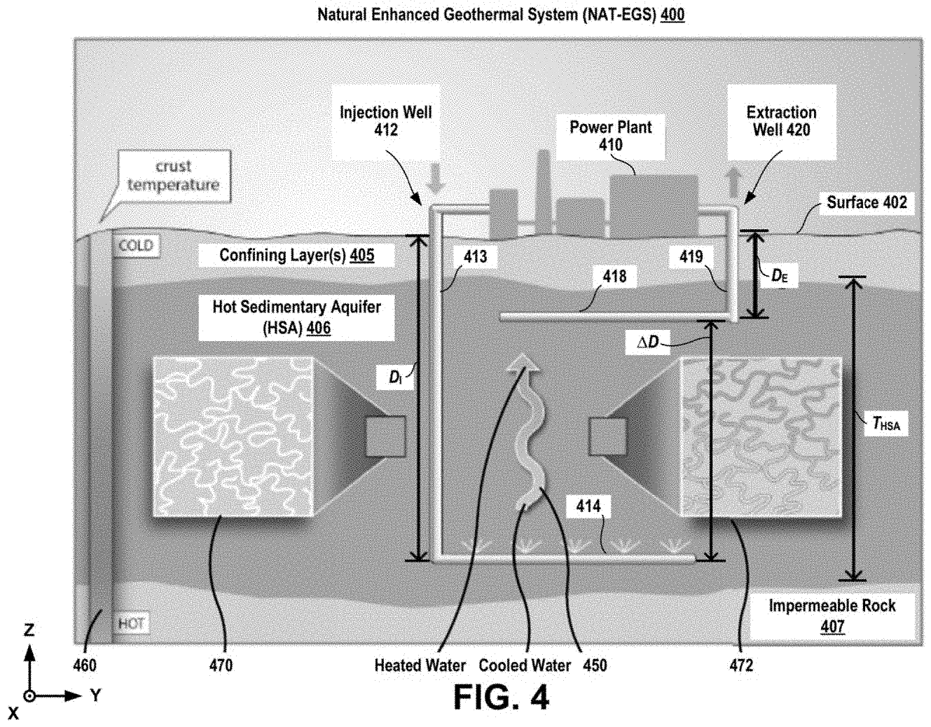

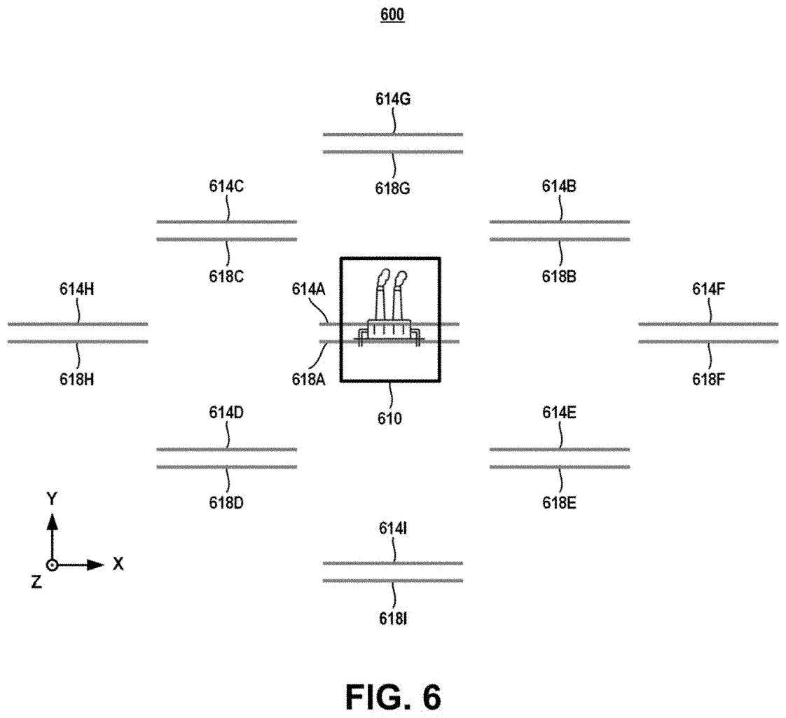

In one example, a convective flow of water through a thick-bed aquifer cart be induced in a substantially vertical system. In such vertical systems, large-scale convection can occur due to the effects of the local thermal gradient, gravity, and/or pumping pressures within the system. By constructing a vertical system in an aquifer having the necessary permeability, porosity, and fracture systems (whether natural or man-made) to enable convective flow to occur, and then controlling such factors as the vertical and horizontal distances between wells, well depth, pumping pressures, and water flow rates, convective flow can be induced. Such convection then allows for the efficient mixing of the pumped water with the surrounding hot aquifer water, thereby recharging the system. Such a convective flow can be induced in a RAD-EGS (e.g., RAD-EGS 300 described with reference to FIG. 3), a natural geothermal system (e.g., geothermal system 100 described with reference to FIG. 1), a NAT-EGS (e.g., NAT-EGS 400 described with reference to FIG. 4), and a multi-well system (e.g., multi-well system 600 described with reference to FIG. 6). Various RAD-EGS configurations and techniques are described in more detail in. U.S. patent application Ser. No. 17/443,137, filed Jul. 21, 2021, and titled “METHOD FOR A RADIATOR EGS TO HARVEST GEOTHERMAL ENERGY,” U.S. Pat. No. 11,125,471, issued Sep. 21, 2021, and titled “METHOD FOR RADIATOR EGS TO HARVEST GEOTHERMAL ENERGY,” and U.S. Provisional Application No. 62/007,667, filed Jun. 4, 2014, and titled “METHOD FOR A RADIATOR EGS TO HARVEST GEOTHERMAL ENERGY,” each of which is incorporated by reference herein in its entirety. Various NAT-EGS configurations and techniques are described in more detail in International Patent Application No. PCT/US2020/070305, filed Jul. 23, 2020, and titled “NATURAL ENHANCED GEOTHERMAL SYSTEM USING A HOT SEDIMENTARY AQUIFER,” and U.S. Provisional Application No. 62/979,033, filed Feb. 20, 2020, and titled “NATURAL ENHANCED GEOTHERMAL SYSTEM USING A HOT SEDIMENTARY AQUIFER,” each of which is incorporated by reference herein in its entirety. Various multi-well configurations and techniques for utilizing multiple pairs of extraction and injection wells are described in more detail in U.S. patent application Ser. No. 17,554,126, filed Dec. 17, 2021, and titled “'MULTIPLE WELL PAIRS FOR SCALING THE OUTPUT OF GEOTHERMAL ENERGY POWER PLANTS,” which is incorporated by reference herein in its entirety.

in another example, a convective flow of water through a thin-bed aquifer can be induced in a substantially horizontal system. In a thin sedimentary aquifer, the convective flow patterns are mostly dominated by inducing a dipolar pumping field between the injection and, extraction wells. A convective flow of water through a thin-bed aquifer can be induced by generating a dipolar pressure field. This dipolar pressure field is created by pumping the hot water out of the extraction well (or wells in a multi-well system) and then pumping the cooled water into the injection well (or wells in a multi-well system). It should be noted that dipolar pressure fields can be used to create convective flow in both thin-bed and thick-bed systems. Specifically, such a dipole-driven convective flow can be induced in a RAD-EGS, a natural geothermal system, a NAT-EGS, a thin-bed NAT-EGS, and a multi-well system.

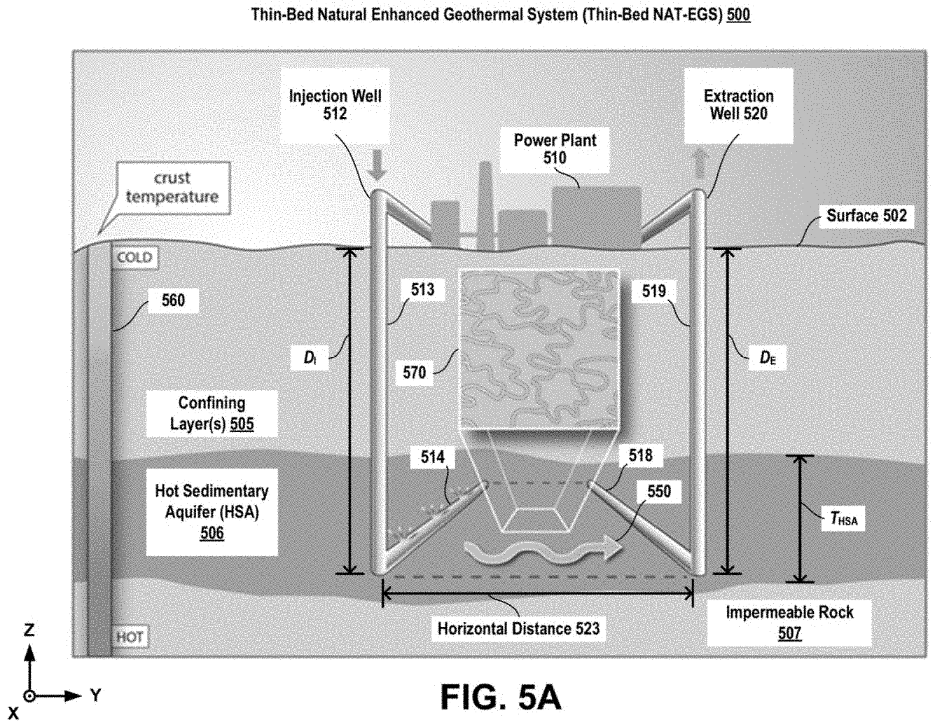

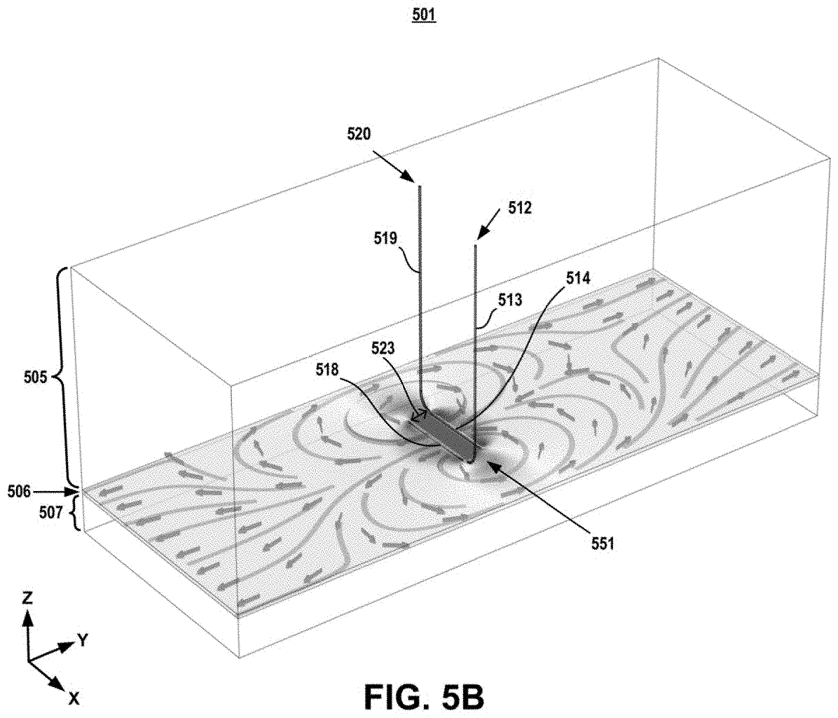

In yet another example, a pressure-driven convective flow of water, through a thick-bed or thin-bed aquifer can be induced by finding an aquifer that is under or over pressured and managing the aquifer's pressure gradients advantageously. Such a pressure-driven convective flow can be induced in a RAD-EGS, a natural geothermal system, a NAT-EGS, a thin-bed NAT-EGS (e.g., thin-bed NAT-EGS 500 described with reference to FIGS. 5A and 5B), and a multi-well system. Various thin-bed NAT-EGS configurations and techniques are described in more detail in U.S. patent application Ser. No. 17/459,438, filed Aug. 27, 2021, and titled “EXTRACTING GEOTHERMAL ENERGY FROM THIN SEDIMENTARY AQUIFERS,” which is incorporated by reference herein in its entirety.

In still another example, a temperature-driven convective flow of water through a thick-bed aquifer can be induced by pumping/ injecting cold water into the bottom of the system and extracting hot water from the top of the system. This temperature differential stimulates convective flow both within the system and within the region surrounding it, bringing the necessary recharge heat into the system. Such a temperature-driven convective flow can be induced in a RAD-EGS, a natural geothermal system, a NAT-EGS, and a multi-well system.

In still another example, a multi-mode convective flow of water and heat through an aquifer can be induced by a combination of two or more of a dipolar pressure driven convective flow, gravity driven, and/or a temperature-driven convective flow. Such a multi-mode convective flow can be induced in a RAD-EGS, a natural geothermal system, a NAT-EGS, a thin-bed NAT-EGS, a multi-well system, or a combination thereof.

In some embodiments, the geothermal systems disclosed herein can provide for, but are not limited to: (i) inducing a large scale subsurface convection flow field by imposing dipolar pressure field through pumping between extraction and, injection wells; (ii) pumping hot water from this subsurface system via an extraction well; (iii) extracting heat or thermal energy from the extracted superheated water via a power generation unit; (iv) using the extracted heat to generate power; and (v) returning, via pumping, the resultant cooled water to the subsurface through an injection well, where the water can be reheated, continuing the cycle. The overall induced convective system allows the harvesting of hot waters over a vastly larger area than that simply represented by the distance between the extraction and reinjection wells and over a vastly longer time, Moreover, the lengths and positioning of the coupled lateral extraction and reinjection wells can be styled or crafted to fit any suitable sedimentary formation.

In some embodiments, the present disclosure provides geothermal systems capable of steadily harvesting economic energy from a wide spectrum of sedimentary aquifers, thick and thin sedimentary aquifers, to generate commercial levels of power for many decades. In some embodiments, the present disclosure provides a method of harvesting geothermal energy that includes, but is not limited to, pumping water into and from the sedimentary aquifer via the injection well and the extraction well, respectively, This pumping process can be designed to create a pressure field that induces or stimulates a convective flow field within the sedimentary aquifer that generates a relatively large-scale zone of mixing between the subsurface waters with the re-injected pumped waters, Subsequently, the extraction well pumps the heated water to the surface and into the conversion unit or power station.

### Definitions

Unless defined otherwise, all technical and scientific terms used herein can have substantially the same meaning as commonly understood by one of ordinary skill in the art to which the disclosure pertains. The following definitions supplement those in the art and are directed to the current application and are not to be imputed to any related or unrelated case, e.g., to any commonly owned patent or application. The terminology used herein is for the purpose of describing particular embodiments only, and is not intended to be limiting.

As used in this specification and the appended claims, the singular forms “a,” “an” and “the” include plural referents unless the context clearly dictates otherwise. Thus, for example, reference to “an attribute” includes a plurality of such attributes, and the like.

The term “about” as used herein indicates the value of a given quantity varies by 10% of the value. For example, a thickness of “about 500 meters” can encompass a range of thicknesses from 450 meters to 550 meters, inclusive.

Spatially relative terms, such as “beneath,” “below,” “lower,” “above,” “on,” “upper” and the like, may be used herein for ease of description to describe one element or feature's relationship to another element(s) or feature(s) as illustrated in the figures, The spatially relative terms are intended to encompass different orientations of the element(s) or feature(s) in use or operation in addition to the orientation(s) depicted in the figures. The element(s) or feature(s) can be otherwise oriented (e.g., rotated 90 degrees or at other orientations) and the spatially relative descriptors used herein may likewise be interpreted accordingly.

The term “natural enhanced geothermal system (NAT-EGS)” and “geothermal convective power cell (geo power cell or GPC)” refer to systems for harvesting geothermal energy from hot sedimentary aquifers without hydraulic fracturing by generating convection cells between a production well and an injection well. As used herein, the term NAT-EGS is synonymous with the term GPC.

The term “characteristic” or “geologic characteristic” can refer to a property, such as a rock property or a seismically-determined property, that is present at substantially all locations in the geologic volume (e.g., penetrative), The rock property can include density, porosity, permeability, and other suitable rock properties, The seismically-determined property can include velocity, Young's modulus, and other suitable seismically-determined properties.

The term “permeability” can refer to the various geologic characteristics that form the bulk permeability of a geologic volume, such as an HSA. These geologic characteristics can include, but are not limited to, the permeability of the rock itself, the distribution and degree of existing fractures in the formation, and any new fractures that are induced (e.g., via acid and/or energetics) to increase and/or enhance the bulk permeability of the geologic volume.

In some embodiments, the term “fracture” or “natural fracture” can refer to any non-sedimentary mechanical discontinuity thought to represent a surface or zone of mechanical failure. Chemical processes such as solution and stress corrosion may have played an important role in the fracture process. The term “fracture” can be used to describe a natural feature either when available evidence is inadequate for exact classification or when distinction between fracture types is unimportant. In some embodiments, faults are types of fractures. In some embodiments, an “induced fracture” can refer to any rock fracture produced by human activities, such as drilling, accidental or intentional hydrofracturing, core handling, and other activities.

In some embodiments, the term “machine learning” can refer to multivariate-statistics, neural networks, deep neural networks, and other suitable techniques, and any combination thereof. Accordingly, the term “machine learning” as used herein can include all possible correlation methods including multivariate statistics and neural networks.

The term “hot sedimentary aquifer (HSA)” can refer to a sedimentary rock stratum or sequence of strata filled with water (e.g., fresh, saline, or brine) that is sufficiently hot and that has sufficient porosity and permeability to be an economical source of geothermal energy. The term “thick-bed HSA” can refer to an HSA having a thickness between about 100 meters and 500 meters or more. The term “thin-bed HSA” can refer to an HSA having a thickness equal to or less than about 100 meters.

### Example Geothermal Systems

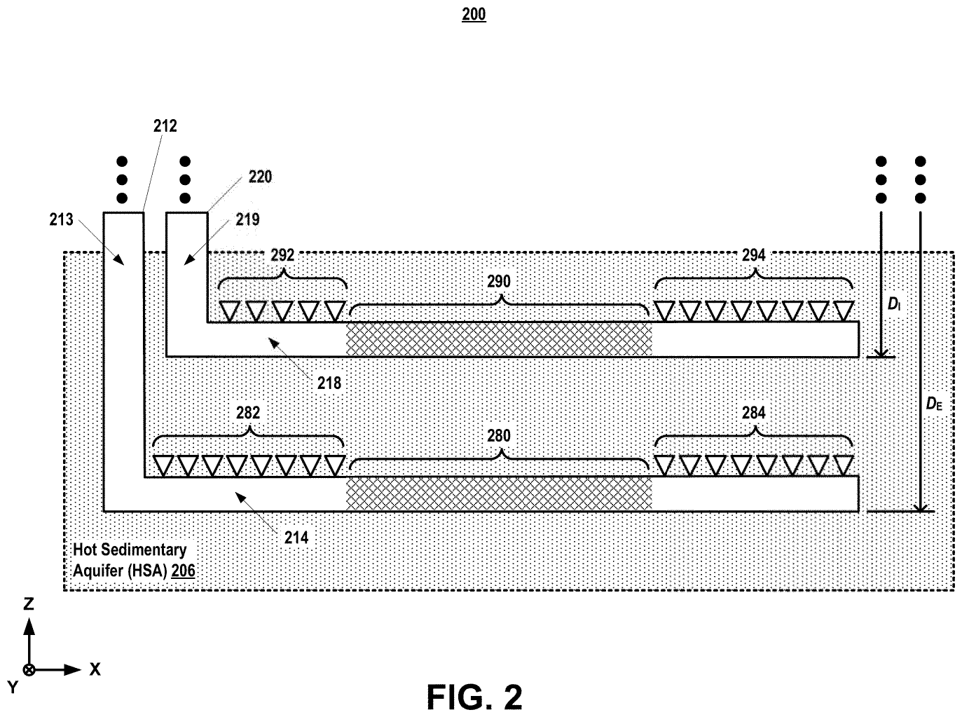

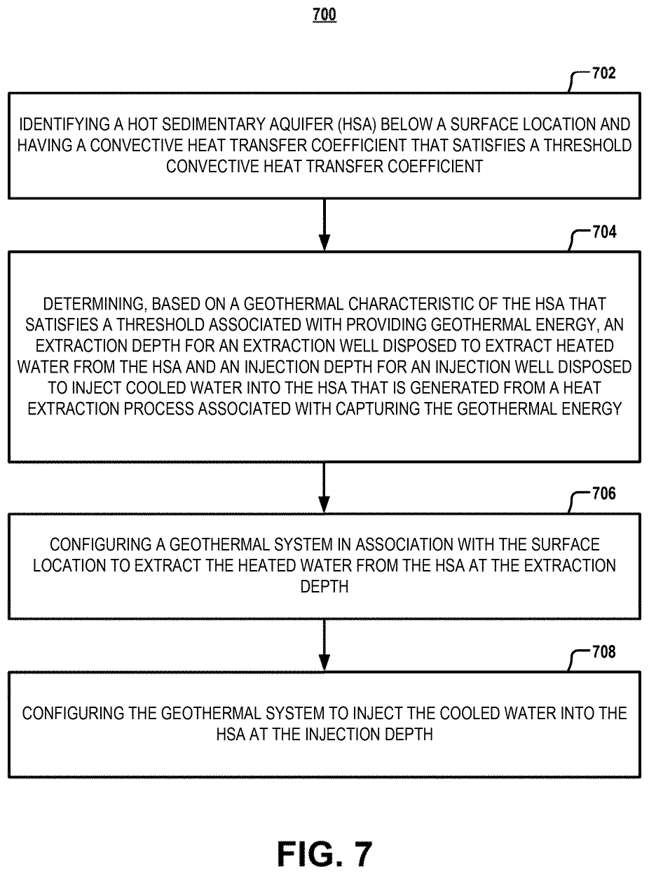

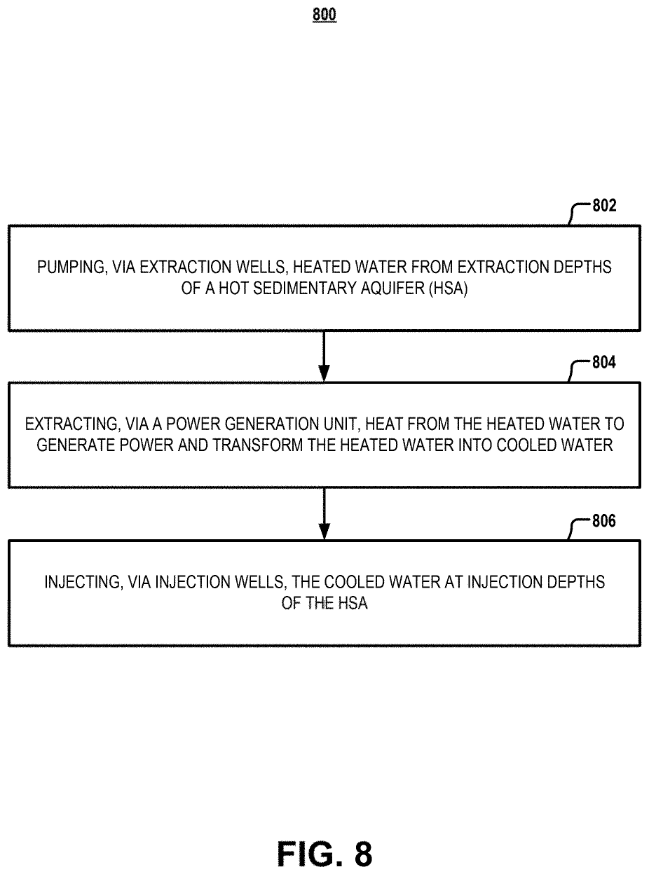

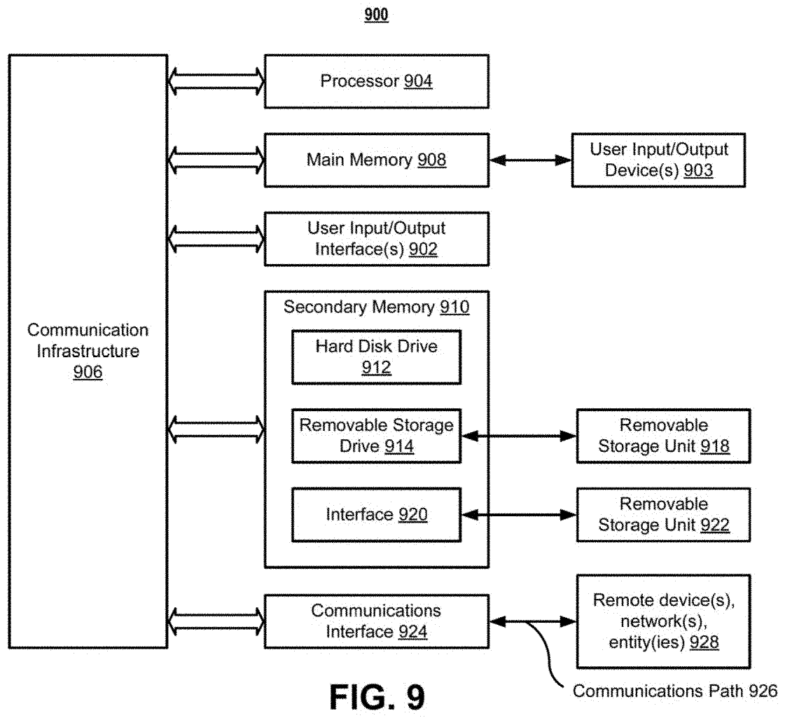

FIG. 1 is a schematic diagram of an implementation of a geothermal system 100 (e.g., a natural geothermal system), according to some embodiments. In some embodiments, the geothermal system 100 may be configured to extract heat from an HSA 106. in some aspects, the geothermal system 100, or any portion thereof, can be implemented using any of the structures, components, features, or techniques described with reference to the well pair 200 described with reference to FIG. 2; the RAD-EGS 300 described with reference to FIG. 3; the NAT-EGS 400 described with reference to FIG. 4: the thin-bed NAT-EGS 500 described with reference to FIGS. 5A and 5B; the multi-well geothermal system 600 described with reference to FIG. 6; the method 700 described with reference to FIG. 7; the method 800 described with reference to FIG. 8; the computer system 900 described with reference to FIG. 9; any other suitable structure, component, feature, or technique; any portion thereof; or any combination thereof. In some embodiments, one or more of the operations described below with reference to FIG. 1 may be performed or otherwise carried out by one or more components of the computer system 900.

As shown in FIG. 1, a power unit 110 (e.g., a power plant or other type of geothermal energy processing or utilization facility) associated with the geothermal system 100 is positioned on a surface 102 of a location that is above, over, or near a geologic volume 104 that includes an HSA 106 (or, alternatively, a radiator vane as described with reference to FIG. 3), The geothermal system 100 includes an extraction well 120 with an extraction lateral 118 and an injection well 112 with an injection lateral 114. The extraction well 120 and the injection well 112 may have been drilled to various depths of the HSA 106 and may be either vertically aligned or horizontally separated.

The power unit 110 can include a pump system, a power generation unit (e.g., including, but not limited to, an energy capture unit and an energy conversion unit to convert geothermal energy to mechanical energy, electrical energy, any other suitable form of energy, or any combination thereof), and a regulatory device to control the geothermal system 100. For example, the regulatory device may control an extraction pump of the pump system to extract water from the HSA 106 via the extraction well 120. In another example, the regulatory device may control the power generation unit to capture and process geothermal energy from the heated water, resulting in cooled water. In still another example, the regulatory device may control the injection pump to inject the cooled water from the power generation unit into the HSA 106 via the injection well 112. In some embodiments, the power unit 110 may be configured based on a determined optimum range of the water injection rate via the injection well 112 and/or the water extraction rate via the extraction well 120 that can produce commercial levels of energy or power. Further, the flow rate of the water (e.g., as indicated by water flow 116) can be tuned (e.g., over time) via pumping adjustments to achieve a best possible efficiency for the geothermal system 100 according to the characteristics of the HSA 106.

Although the water flow 116 is shown as being substantially parallel to the Z-axis, in some embodiments, the water flow 116 can be substantially parallel to the Y-axis, substantially along a vector in the YZ-plane, or along any other suitable trajectory or flow path. For example, in some embodiments, a thickness of the HSA 106 can be greater than about 100 meters, and a horizontal distance along the Y-axis between the extraction lateral 118 and the injection lateral 114 can be less than about 300 meters, resulting in the water flow 116 being substantially parallel to the Z-axis or substantially along a vector in the YZ-plane closer to the Z-axis. In another example, in some embodiments, a thickness of the HSA 106 can be equal to or less than about 100 meters, and a horizontal distance along the Y-axis between the extraction lateral 118 and the injection lateral 114 can be equal to or greater than about 300 meters, resulting in the water flow 116 being substantially parallel to the Y-axis or substantially along a vector in the YZ-plane closer to the Y-axis. In yet another example, in some embodiments, the extraction lateral 118 can be disposed below the injection lateral 114, resulting in the water flow 116 being substantially parallel to the negative Z-axis or substantially along a vector in the YZ-plane closer to the negative Z-axis.

Regarding the terrain of the geothermal system 100 (e.g., as indicated by geologic volume 104), the surface 102 may correspond to a layer or layers of ground and underground or soil surface, a water surface (e ,g., a lake surface, ocean surface, river surface), or any other suitable type of surface of the Earth. The HSA 106 can be disposed beneath the surface 102 (e.g., beneath the power unit 110) and may include any suitable type of fresh or salt-water bearing sedimentary rock. In some embodiments, the HSA 106 may be configured above and/or between one or more layers of igneous rock.

In some embodiments, the location of the surface 102 may be selected for the power unit 110 based on one or more geothermal characteristics of the HSA 106. For example, the location of the surface 102 may be selected based on determining that the HSA 106 is at a suitable, manageable, and/or accessible depth and includes a sufficient volume of water at a sufficiently high temperature, to determine whether the HSA 106 can efficiently be used to capture geothermal energy from the Earth. The HSA 106 (and/or geothermal characteristics of the HSA 106) may initially be identified and/or analyzed from drilling and sampling the terrain beneath the surface 102. Additionally or alternatively, the HSA 106 may be identified and/or analyzed from seismic, imaging data (e.g., mapping data, imaging data, etc.) associated with the terrain beneath the surface 102. The seismic it data may be obtained and/or captured in real-time and/or may correspond to historical data associated with previous seismic imaging and/or previously created well bores associated with previous operations, analyses, and/or geological mappings of the terrain beneath the surface 102.

In some embodiments, the geothermal characteristic of the HSA 106 may correspond to one or more characteristics of the HSA 106 that would enable a desired amount of geothermal energy to be extracted from the Earth at a particular rate, for a particular period of time, or both. Such geothermal characteristics may be based on certain physical characteristics of the HSA 106 (e.g., depth, thickness, porosity, permeability, temperature of the HSA 106, and/or pressure and/or composition of water within the HSA 106).

One of the geothermal characteristics of the HSA 106 that may be considered when selecting the location of the surface 102 for the power unit 110 can include or be associated with a measured or determined heat flow between various depths of the HSA 106. The heat flow may indicate and/or, represent an amount of heat or geothermal energy that can be captured from the HSA 106 during a particular time period. The heat flow can be based on the geothermal gradient and determine the temperature of the water at various depths of the HSA 106. Accordingly, the heat flow can be determined (e.g., estimated) based on certain characteristics and/or measurements associated with the HSA 106.

Another of the geothermal characteristics can include or be associated with permeability (e.g., bulk permeability) of the HSA 106. The permeability of the HSA 106 may indicate the rate at which water can be extracted from the. HSA 106. Correspondingly, in combination with temperatures of the HSA 106 (e.g., at, various depths of the HSA 106). the amount of heat or geothermal energy that can be extracted from the HSA 106 can be determined. The permeability of the HSA 106 may be determined based on various tests conducted in the associated drill holes into the HSA 106 and, in some embodiments, further based on the terrain of the HSA 106. According to some implementations, a construction lateral can be drilled between or beyond the injection lateral 114 and the extraction lateral 118 to perform an operation to improve the permeability of the HSA 106. For example, such a construction lateral can be drilled outside of the injection/extraction lateral plane to increase the permeability of the region surrounding the well pair to stimulate increased convective flow into the system from the region beyond the well pair (e.g., also referred to as “the far field”), in another example, such a construction lateral may be drilled and configured to inject acidic water and/or pressurized water (and/or an energetic or propellant, such as an ignitable liquid or solid fuel) to increase the bulk permeability, porosity, and/or convective heat transfer coefficient of the HSA 106, thereby improving the permeability between the injection lateral 114 and the extraction lateral 118. In such cases, the permeability of the HSA 106 may satisfy a permeability threshold associated with permitting the construction lateral to be drilled. In some embodiments, such a threshold permeability may be greater than a permeability threshold to use the HSA 106 without performing enhancement operation to increase the permeability of the HSA 106 to configure the geothermal system 100.

Yet another of the geothermal characteristics can include or be associated with a porosity of the HSA 106, which can indicate the volume of water held by the HSA 106. The porosity may indicate or be used to identify the permeability and enable a determination of a flow rate of water through the HSA 106, an amount of water that can be received within the HSA 106 after being processed by the power unit 110 (e.g., to determine an injection rate of a flow of water via the injection well 112).

Still another of the geothermal characteristics can include or be associated with a convective heat transfer coefficient of the HSA 106. The convective heat transfer coefficient is the rate of heat transfer between a solid (e.g., rock) and a fluid (e.g., water or brine). The convective heat transfer coefficient may be, for example, a bulk or average convective heat transfer coefficient in units of watts per meter-squared kelvin (W/(m²K)), referred to using the symbol “h” The convective heat transfer coefficient of the HSA 106 may indicate the proportionality constant between the heat flux and the temperature difference for the flow of heat in the HSA 106. For example, the convective heat transfer coefficient of the HSA 106 can be indicative of free convection, forced convection, or both resulting from the motion of fluid (e.g., water; water mixed with a supplemental agent) within the HSA 106 as indicated by the water flow 116. In some embodiments, the convective heat transfer coefficient can be determined according to an analysis of geologic data associated with the HSA 106 that provides for sufficient convective thermal recharge of the heated water extracted from the HSA 106 by the extraction well 120.

In some embodiments, the convective heat transfer within the HSA 106 can be indicative of free convection based on a gravity-driven convective flow of water through the HSA 106 induced by a gravitational field within the HSA 106. For example, the extraction lateral 118 of the extraction well 120 can be disposed within a first region of the HSA 106, the injection lateral 114 of the injection well 112 can be disposed within a second region of the HSA 106, and the vertical distance 122 between the extraction depth DE of the extraction lateral 118 and the injection depth DI of the injection lateral 114 can be equal to or greater than a threshold depth distance that, provides, based on the gravity-driven convective flow of the water through the HSA 106, a convective heat transfer rate within the HSA 106 that satisfies a threshold convective heat transfer rate sufficient to provide a convective thermal recharge of the heated water extracted from the HSA 106 by the extraction well 120. The convective heat transfer rate may be, for example a bulk or average convective heat transfer rate in units of watts (W), referred to using the symbol “Q.”

In some embodiments, the convective heat transfer within the HSA 106 can be indicative of free convection based on a pressure-driven convective flow of water through the HSA 106 induced by a natural pressure gradient within the HSA 106. For example, the natural pressure gradient can be equal to or greater than a threshold natural pressure gradient that provides, based on the pressure-driven convective flow of the water through the HSA 106, a convective heat transfer rate within the HSA 106 that satisfies a threshold convective heat transfer rate sufficient to provide a convective thermal recharge of the heated water extracted from the HSA 106 by the extraction well 120.

In some embodiments, the convective heat transfer within the HSA 106 can be indicative of forced convection based on a convective flow of water through the HSA 106 induced by a dipolar pressure gradient formed within the HSA 106 in response to pumping the heated water from the HSA 106 at the extraction depth and injecting the cooled water into the HSA 106 at the injection depth Di. For example, the dipolar pressure gradient can be equal to or greater than a threshold dipolar pressure gradient that provides, based on the convective flow of the water through the HSA 106, a convective heat transfer rate within the HSA 106 that satisfies a threshold convective heat transfer rate sufficient to provide a convective thermal recharge of the heated water extracted from the HSA 106 by the extraction well 120.

In some embodiments, the convective heat transfer within the HSA 106 can be indicative of free convection based on a temperature-driven convective flow of water through the HSA 106 induced by a temperature gradient formed within the HSA 106 in response to pumping the heated water from the HSA 106 at the extraction depth D_{E} and injecting the cooled water into the HSA 106 at the injection depth D_{I}. For example, the temperature gradient can be equal to or greater than a threshold temperature gradient that provides, based on the temperature-driven convective flow of the water through the HSA 106, a convective heat transfer rate within the HSA 106 that satisfies a threshold convective heat transfer rate sufficient to provide a convective thermal recharge of the heated water extracted from the HSA 106 by the extraction well 120.

In some embodiments, the convective heat transfer within the HSA 106 can include a multi-mode heat transfer within the HSA 106 indicative of two or more of: a gravity-driven convective flow of water through the HSA 106 induced by a gravitational field within the HSA 106; a pressure-driven convective flow of water through the HSA 106 induced by a natural pressure gradient within the HSA 106; a convective flow of water through the HSA. 106 induced by a dipolar pressure gradient formed within the HSA 106 based on the pumping the heated water from the extraction depth and the injecting the cooled water at the injection depth; and a temperature-driven convective flow of water through the HSA 106 induced by a temperature gradient formed within the 106 based on the pumping the heated water from the extraction depth and the injecting the cooled water at the injection depth. For example, the convective heat transfer within the HSA 106 can be indicative of a convective flow of water through the HSA 106 induced by thermal gradients and gravitational fields within the HSA 106.

Such geothermal characteristics may be compared against corresponding thresholds of the geothermal characteristics to determine whether the HSA 106 is suitable for capturing a desired amount of geothermal energy (e.g., corresponding to enough energy to permit the power unit 110 to output a desired amount of power for an area or region of the location of the surface 102) for a desired period of time (e.g., 10-20 years, or even over 50 years). :In some embodiments, the thresholds may include a minimum heat flow rate into the HSA 106, a minimum permeability of the HSA 106, a minimum porosity of the HSA 106, a minimum convective heat transfer coefficient of the HSA 106, any other suitable threshold, or any combination thereof. Additionally or alternatively, certain physical characteristics of the HSA 106 associated with geothermal characteristics of the HSA 106 may be considered (e.g., a minimum or maximum depth of the HSA 106, a minimum or maximum thickness of the HSA 106, a minimum temperature of the HSA 106).

In some embodiments, the geothermal system 100 may use the HSA 106 that has a sufficiently high convective heat transfer coefficient (e.g., due to a sufficiently high background basal heat flux, among other characteristics) and is sufficiently large enough (e.g., has a sufficient volume, thickness) to supply geothermal energy for ten years or more. In some locations of the Earth, such an injection depth of the HSA 106 may be at a minimum of 1,500 meters below the surface 102, and/or such an extraction depth of the HSA 106 may be at a minimum of 1,000 meters. In such an example, any recirculated water that was injected via the injection well 112 and extracted via the extraction well 120 can reach the threshold temperature of at least 100 degrees Celsius (° C.) e.g., for advanced organic Rankine cycle (ORC) power generation technologies) or lower (e.g., in the case of district heating). For higher levels of basal heat flux, the minimum depth becomes correspondingly less.

In some embodiments, after the location of the surface 102 is selected for the power unit 110, the geothermal system 100 may be configured and/or designed according to the characteristics of the HSA 106. For example, as shown, the injection well 112 and the extraction well 120 may be part of a well system connected to the power unit 110 in that heated water is to be extracted from the. HSA 106 at an extraction depth and cooled water (which is created from capturing heat from the heated water) is to be injected at an injection depth of the HSA 106. In some embodiments, based on the geothermal characteristics of the HSA 106 and the desired amount of geothermal energy that is to be captured from the HSA 106, the extraction depth and injection depth (and, correspondingly, the vertical distance 122 between the extraction depth of the extraction lateral 118 and the injection depth of the injection lateral 114), as well as the extraction location and the injection location (and, correspondingly, the distance 123 between the extraction well 120 and the injection well 112), can be determined to provide a desired water flow rate and/or energy extraction rate for a desired period of time that the power unit 110 is to be operable to provide power. As a result, the extraction well 120 and the injection well 112 may be offset laterally, vertically, or both laterally and vertically.

In some embodiments, the regulatory device can be configured to generate a first control signal configured to instruct the pump system to pump, via the extraction well 120, the heated water from the HSA 106 at the extraction depth D_{E} to the power generation unit. In some embodiments, the first control signal can be further configured to instruct the pump system to pump, via the extraction well 120, the heated water from the HSA 106 at the extraction depth D_{E} at an extraction rate that stimulates a convective flow field. The convective now field can include, for example, a convective heat transfer rate that satisfies a threshold convective heat transfer rate that provides a convective thermal recharge of the extracted heat. In some embodiments, the regulatory device can be further configured to generate a second control signal configured to instruct the power generation unit to extract heat from the heated water to generate power and transform the heated water into the cooled water. In some embodiments, the regulatory device can be further configured to generate a third control signal configured to instruct the pump system to pump, via the injection well 112, the cooled water from the power generation unit into the HSA 106 at the injection depth D_{I}. In some embodiments, the third control signal can be further configured to instruct the pump system to pump, via the injection well 112, the cooled water into the HSA 106 at the injection depth a at an injection rate that further stimulates the convective flow field.

In some embodiments, the third control signal can be further configured to instruct the pump system to inject the cooled water with a supplemental agent to stimulate the convective flow of water through the HSA 106. The supplemental agent can include, for example, a solvent or solute (e.g., a hydrochloric acid such as muriatic acid; a sulfuric acid; or any other suitable material for performing acid leaching), any other suitable agent, or any combination thereof. When injected into the HSA 106 via the injection well 112 (e.g., along with the cooled water), the supplemental agent can increase the permeability, porosity, and/or convective heat transfer coefficient of the HSA 106 (e.g., by causing, erosion or breakdown of some of the rock or material of the HSA 106). In this way, the geothermal system 100, using the supplemental agent, can improve geothermal energy extraction via the HSA 106.

In some embodiments, the well system can be configured to stimulate the convective flow field within the HSA 106 based on a first pumping of the heated water from the HSA 106 at the extraction depth D_{E} responsive to the first control signal and further based on a second pumping of the cooled water into the HSA 106 at the injection depth D_{I} responsive to the third control signal. In some embodiments, the regulatory device can be configured to modify the first control signal, the second control signal, the third control signal, or a combination thereof based on measurements of the convective flow field obtained by instrumentation devices disposed on the extraction lateral 118 and the injection lateral 114 (e.g., as described with reference to FIG. 2). In such aspects, the well system can be configured to modify the stimulation of the convective flow field within the HSA 106 based on a modified first pumping of the heated water from the HSA 106 at the extraction depth D_{E}, responsive to a modified first control signal and further based on a modified second pumping of the cooled water into the HSA 106 at the injection depth D_{I} responsive to a modified third control signal.

FIG. 2 is a schematic diagram of a well pair 200 having instrumentation devices for measuring characteristics associated with a convective flow field, according to some embodiments. As shown in FIG. 2, the well pair 200 can include an injection well 212 and an extraction well 220. The injection well 212 and the extraction well 220 can be L-shaped in that each of the injection well 212 and the extraction well 220 each can have a vertical component and a horizontal (e.g., lateral) component. For example, the extraction well 220 may have a production element including a vertical extraction component 219 that extends between an extraction depth D_{E} and the power plant at a surface above an HSA 206 (or, in other embodiments, a radiator vane as described with reference to FIG. 3). The production element of the extraction well 220 can further include an extraction lateral 218 that is laterally drilled at the extraction depth D_{E}. The extraction lateral 218 may be mechanically coupled (e.g., physically attached to, physically fastened to, fluidly coupled, and/or the like) to the vertical extraction component 219 and laterally branch out from the vertical extraction component 219 at the extraction depth D_{E}. In another example, the injection well 212 may have an injection element including a vertical injection component 213 that extends between the injection depth D and the power plant at the surface. The injection element of the injection well 212 can further include an injection lateral 214 that is laterally drilled at the injection depth D_{I}. The injection lateral 214 may be mechanically coupled to the injection element and laterally branch out from the vertical injection component 213 at the injection depth D_{I}.

The well pair 200 can include various instrumentation devices (e.g., fiberoptics, sensors, metrology took, etc.) configured to measure characteristics associated with the convective flows stimulated by the techniques disclosed herein. For example, the injection lateral 214 may include a horizontal perforated pipe zone 280, a first set of instrumentation devices 282 disposed at the heel of the injection lateral 214, and a second set of instrumentation devices 284 disposed at the toe of the injection lateral 214. The first set of instrumentation devices 282 and the second set of instrumentation devices 284 can be configured to monitor the temperature, pressure, gravity, fluid flow, any other suitable characteristic, any differential thereof, or any combination thereof in order to measure the convective flows near the heel and toe of the injection lateral 214, respectively, without having to drill monitoring holes, In another example, the extraction lateral 218 may include a horizontal perforated pipe zone 290, a third set of instrumentation devices 292 disposed at the heel of the extraction lateral 218, and a fourth set of instrumentation devices 294 disposed at the toe of the extraction lateral 218. The third set of instrumentation devices 292 and the fourth set of instrumentation devices 294 can be configured to monitor the temperature, pressure, gravity, fluid flow, any other suitable characteristic, any differential (e.g., first-order differential, second-order differential) thereof, or any combination thereof in order to measure the convective flows near the heel and toe of the extraction lateral 218, respectively, without having to drill monitoring holes.

The measurements obtained by the first set of instrumentation devices 282, the second set of instrumentation devices 284, the third set of instrumentation devices 292, and the fourth set of instrumentation devices 294 can be used to determine characteristics of the convective flow field within the HSA 206 between the infection lateral 214 and the extraction lateral 218.

FIG. 3 illustrates a schematic diagram of a single-vane unit of a RAD-EGS 300 that includes one or more vane units, according to some embodiments. In some aspects, the RAD-EGS 300, or any portion thereof, can be implemented using any of the structures, components, features, or techniques described with reference to the geothermal system 100 described with reference to FIG. 1; the well pair 200 described with reference to FIG. 2; the NAT-EGS 400 described with reference to FIG. 4; the thin-bed NAT-EGS 500 described with reference to FIGS. 5A and 5B; the multi-well geothermal system 600 described with reference to FIG. 6; the method 700 described with reference to FIG. 7; the method 800 described with reference to FIG. 8; the computer system 900 described with reference to FIG. 9; any other suitable structure, component, feature, or technique; any portion thereof; or any combination thereof. In some embodiments, one or more of the operations described below with reference to FIG. 3 may be performed or otherwise carried out by one or more components of the computer system 900.

In some embodiments, the RAD-EGS 300 can include a power generation unit, a pump system, a well system disposed within a vane 306, and a regulatory device. As used herein, the term “vane” refers to a vertically-oriented, “manufactured” hydrothermal fracture system.

The vane 306 can be identified or selected based on a convective heat transfer coefficient of the vane 306 satisfying a threshold convective heat transfer coefficient (e.g., based on a gravity-driven, pressure-driven, dipole-driven, and/or temperature-driven convective flow of water through the vane 306, or a combination thereof as described above with reference to FIGS. 1-2 and/or below with reference to FIGS. 7-8). The well system can include an extraction well 320 that enables the pump system to extract heated water from the vane 306 at an extraction depth (e.g., a depth of a first isothermal surface 354) and provide the heated water to the power generation unit. The well system can further include an injection well 312 that enables the pump system to inject cooled water from the power generation unit into the vane 306 at an injection depth (e.g., a depth of a second isothermal surface 356).

As shown in FIG. 3, the RAD-EGS 300 can include the injection well 312 and the extraction well 320 as a vane unit. The injection well 312 can include a vertical injection component 313 and an injection lateral 314 connected to a first pumping unit of the pump system. The extraction well 320 can include a vertical extraction component 319 and an extraction lateral 318 connected to a second pumping unit of the pump system. While FIG. 3 illustrates a single-vane unit including one pair of wells, the RAD-EGS 300 can include any number of wells as will be understood and appreciated by one of ordinary skill in the art(s) to which the disclosure pertains.

As further shown in FIG. 3, each of the injection well 312 and the extraction well 320 can be substantially parallel to the maxi farm horizontal stress (S_{H,max}) 350 and drilled to a respective depth e.g., greater than 700 meters) where the principal stress axis (S₁) 352 is substantially vertical. The extraction lateral 318 can be drilled to a first depth corresponding to the first isothermal surface 354 having a temperature Tₘᵢₙ that is greater than a minimum temperature required for commercial energy production (T The injection lateral 314 can, be drilled to a second depth corresponding to the second isothermal surface 356 having a temperature The second depth can be greater (e.g., deeper below the Earth's crust) than the first depth.

In some embodiments, the length (l₃) of the vertical injection component 313 below the first isothermal surface 354 and the length (l₂) of the injection lateral 314 can be determined by the relationship V_{crit}=l₁×l₂×l₃, where l₁ refers to the distance between successive vanes, and V_{crit} refers to the volume necessary to maintain a temperature of the heated fluid produced at the extraction well 320 that is greater than or equal to Tₑ for a sufficient amount of time that it will meet the economic criteria for commercial power generation. In some aspects, the volume V_{crit} can represent a single “radiator” cell. In such aspects, when Tₘᵢₙ is greater than Tₑ (e.g., the temperature required for commercial production), the temperature of the radiator cell can be allowed to go to Tₑ.

In some embodiments, the regulatory device can be configured to generate a first control signal configured to instruct the pump system to pump, via the extraction well 320, the heated water from the vane 306 at the extraction depth to the power generation unit. In some embodiments, the first control signal can be further configured to instruct the pump system to pump, via the extraction well 320 the heated water from the vane 306 at the extraction depth at an extraction rate that stimulates a convective flow field. The convective flow field can include, for example, a convective heat transfer rate that satisfies a threshold convective heat transfer rate that provides a convective thermal recharge of the extracted heat. In some embodiments, the regulatory device can be further configured to generate a second control signal configured to instruct the power generation unit to extract heat from the heated water to generate power and transform the heated water into the cooled water. In some embodiments, the regulatory device can be further configured to generate a third control signal configured to instruct the pump system to pump, via the injection well 312, the cooled water from the power generation unit into the vane 306 at the injection depth. In some embodiments, the third control signal can be further configured to instruct the pump system to pump, via the injection well 312, the cooled water into the vane 306 at the injection depth at an injection rate that further stimulates the convective flow field. In some embodiments, the well system can be configured to stimulate the convective flow field within the vane 306 based on a first pumping, of the heated water from the vane 306 at the extraction depth responsive to the first control signal and further based on a second pumping of the cooled water into the vane 306 at the injection depth responsive to the third control signal.

In some implementations, the RAD-EGS 300 can supply the cooled water with a supplemental agent to facilitate the flow of available water through the vane 306. The supplemental agent can include, for example, a solvent or solute (e.g., muriatic acid, hydrochloric acid), any other suitable agent, or any combination thereof. When injected into the vane 306 via the injection well 312 (e.g., along with the cooled water), the supplemental agent can increase the permeability, porosity, and/or convective heat transfer coefficient of the vane 306 (e.g., by causing erosion or breakdown of some of the rock or material of the vane 306). In this way, the RAD-EGS 300, using the supplemental agent, can improve geothermal energy extraction via the vane 306.

The regulatory device can be configured to generate a first control signal configured to instruct the pump system to pump, via the extraction well 320, the heated water from the vane 306 at the extraction depth to the power generation unit. In some embodiments, the first control signal can be further configured to instruct the pump system to pump, via the extraction well 320, the heated water from the vane 306 at the extraction depth at an extraction rate that stimulates a convective flow field. The convective flow field can include, for example, a convective heat transfer rate that satisfies a threshold convective heat transfer rate that provides a convective thermal recharge of the extracted heat. hi some embodiments, the regulatory device can be further configured to generate a second control signal configured to instruct the power generation unit to extract heat from the heated water to generate power and transform the heated water into the cooled water. In some embodiments, the regulatory device can be further configured to generate a third control signal configured to instruct the pump system to pump, via the injection well 312, the cooled water from the power generation unit into the vane 306 at the injection depth. In some embodiments, the third control signal can be further configured to instruct the pump system to pump, via the injection well 312, the cooled water into the vane 306 at the injection depth at an injection rate that further stimulates the convective flow field.

In some embodiments, the third control signal can be further configured to instruct the pump system to inject the cooled water with a supplemental agent to stimulate the convective flow of water through the vane 306. The supplemental agent can include, for example, a solvent or solute (e.g., muriatic acid, hydrochloric acid), any other suitable agent, or any combination thereof. When injected into the vane 306 via the injection well 312 (e.g., along with the cooled water), the supplemental agent can increase the permeability, porosity, and/or convective heat transfer coefficient of the vane 306 (e.g., by causing erosion or breakdown of some of the rock. or material of the vane 306). In this way, the RAD-EGS 300, using the supplemental agent, can improve geothermal energy extraction via the vane 306.

In some embodiments, the well system can be configured to stimulate the convective flow field within the vane 306 based on a first pumping of the heated water from the vane 306 at the extraction depth responsive to the first control signal and further based on a second pumping of the cooled water into the vane 306 at the injection depth responsive to the third control signal. In some embodiments, the regulatory device can be configured to modify the first control signal, the second control signal, the third control signal, or a combination thereof based on measurements of the convective flow field obtained by instrumentation devices disposed on the extraction lateral 318 and the injection lateral 314 (e.g., as described with reference to FIG. 2). In such aspects, the well system can be configured to modify the stimulation of the convective flow field within the vane 306 based on a modified first pumping of the heated water from the vane 306 at the extraction depth D_{E} responsive to a modified first control signal and further based on a modified second pumping of the cooled water into the vane 306 at the injection depth Di responsive to a modified third control signal.

FIG. 4 is a schematic diagram of an example implementation of a NAT-EGS 400 (e.g., a GPC) in a thin sedimentary aquifer, according to some embodiments. In some aspects, the NAT-EGS 400, or any portion thereof, can be implemented using any of the structures, components, features, or techniques described with reference to the geothermal system 100 described with reference to FIG. 1; the well pair 200 described with reference to FIG. 2; the RAD-EGS 300 described with reference to FIG. 3; the thin-bed NAT-EGS 500 described with reference to FIGS. 5A and 5B; the multi-well geothermal system 600 described with reference to FIG. 6; the method 700 described with reference to FIG. 7; the method 800 described with reference to FIG. 8; the computer system 900 described with reference to FIG. 9; any other suitable structure, component, feature, or technique; any portion thereof; or any combination thereof. In some embodiments, one or more of the operations described below with reference to FIG. 4 may be performed or otherwise carried out by one or more components of the computer system 900.

As shown in FIG. 4, the NAT-EGS 400 can include a power plant 410 that includes a power generation unit, a pump system, a well system disposed within the HSA 406, and a regulatory device. In some embodiments, the HSA 406 can be disposed above an impermeable rock 407. The HSA 406 can be identified or selected based on a convective heat transfer coefficient of the HSA 406 satisfying a threshold convective heat transfer coefficient (e.g., based on a gravity-driven, pressure-driven, dipole-driven, and/or temperature-driven convective flow of water through the HSA 406, or a combination thereof, as described above with reference to FIGS. 1-2 and/or below with reference to FIGS. 7-8).

The well system can include an extraction well 420 that enables the pump system to provide heated water at an extraction depth D_{E} of the HSA 406 to the power generation unit. The extraction well 420 can include a production element that includes an extraction pump, an extraction lateral 418 disposed within the HSA 406 at the extraction depth D_{E}, and a vertical extraction component 419 extending between the extraction depth D_{E} and the power generation unit of the power plant 410.

The well system can further include an injection well 412 that enables the pump system to inject cooled water from the power generation unit into the HSA 406 at an injection depth D_{I}. The injection well 412 can include an injection element that includes an injection pump, an injection lateral 414 disposed within the HSA 406 at the injection depth D_{I}, and a vertical injection component 413 extending between the injection depth D_{I} and the power generation unit of the power plant 410.

In some embodiments, as shown in FIG. 4, the injection depth D_{I} can be substantially deeper than the extraction depth D_{E}. For example, a depth difference ΔD between the extraction depth D_{E} and the injection depth D_{I} (where ΔD=|D_{I}−D_{E}|) can be equal to or less than about the thickness T_{HSA} of the HSA 406 (e.g., on the order of 250 meters or more) and determined according to the geothermal characteristics of the HSA 406.

In such embodiments, the configuration of the injection well 412 and the extraction well 420 (which may be referred to collectively herein as “the wells”) can be “disjointed” in that the wells can be drilled to different depths substantially without creating manmade fractures or openings directly connecting the wells (e.g., between the extraction lateral 418 of the extraction well 420 and the injection lateral 414 of the injection well 412). For example, the terrain of the HSA 406 between the injection well 412 and the extraction well 420 can have a sufficient permeability to create a substantially uninhibited lateral flow of water between the wells, as indicated by reference arrow 450.

In some embodiments, the NAT-EGS 400 may utilize the HSA 406 that has a sufficiently high background basal heat flux and is sufficiently large enough (e.g., has a sufficient volume, thickness, and/or the like) to supply geothermal energy for ten years or more. As an example, to achieve such an efficiency, the temperature of the water at an extraction depth D_{E} of the HSA 406 (and/or within the extraction well 420) may be at least 100 which may be provided by a minimum background basal heat flux (e.g., from below the extraction depth DE) of about 150 milliwatts per square meter (mW/m²), in some locations of the Earth, such an injection depth D_{I} of the HSA 406 may be at a minimum of 1,500 meters below the surface 402, and/or such an extraction depth D_{E} of the HSA 406 may be at a minimum of 1,000 m meters below the surface 402. In such an example, any recirculated water that was injected via the injection well 412 and extracted via the extraction well 120 can reach the threshold temperature of at least 100° C. For higher levels of basal heat flux, the minimum depth can become correspondingly less.

The regulatory device can be configured to generate a first control signal configured to instruct the pump system to pump, via the extraction well 420, the heated water from the LISA 406 at the extraction depth D_{E} to the power generation unit. In some embodiments, the first control signal can be further configured to instruct the pump system to pump, via the extraction well 420, the heated water from the HSA 406 at the extraction depth D_{E} at an extraction rate that stimulates a convective flow field. The convective flow field can include, for example, a convective heat transfer rate that satisfies a threshold convective heat transfer rate that provides a convective thermal recharge of the extracted heat. In some embodiments, the regulatory device can be further configured to generate a second control signal configured to instruct the power generation unit to extract heat from the heated water to generate power and transform the heated water into the cooled water. In some embodiments, the regulatory device can be further configured to generate a third control signal configured to instruct the pump system to pump, via the injection well 412, the cooled water from the power generation unit into the HSA 406 at the injection depth D_{I}. In some embodiments, the third control signal can be further configured to instruct the pump system to pump, via the injection well 412, the cooled water into the HSA 406 at the injection depth at an injection rate that further stimulates the convective flow field.

In some embodiments, the third control signal can be further configured to instruct the pump system to inject the cooled water with a supplemental agent to stimulate the convective flow of water through the HSA 406, The supplemental agent can include, for example, a solvent or solute (e.g., muriatic acid, hydrochloric acid), any other suitable agent, or any combination thereof. When injected into the HSA 406 via the injection well 412 (e.g., along with the cooled water), the supplemental agent can increase the permeability, porosity, and/or convective heat transfer coefficient, of the HSA 406 (e.g., by causing erosion or breakdown of some of the rock or material of the HSA 406). In this way, the NAT-EGS 400, using the supplemental agent, can improve geothermal energy extraction via the HSA 406.

In some embodiments, the well system can be configured to stimulate the convective flow field within the HSA 406 based on a first pumping of the heated water from the HSA 406 at the extraction depth D_{E} responsive to the first control signal and further based on a second pumping of the cooled water into the HSA 406 at the injection depth D_{I} responsive to the third control signal. In some embodiments, the regulatory device can be configured to modify the first control signal, the second control signal, the third control signal, or a combination thereof based on measurements of the convective flow field obtained by instrumentation devices disposed on the extraction lateral 418 and the injection lateral 414 (e.g., as described with reference to FIG. 2), In such aspects, the well system can be configured to modify the stimulation of the convective flow field within the HSA 406 based on a modified first pumping of the heated water from the HSA 406 at the extraction depth D_{E} responsive to the modified first control signal and further based on a modified second pumping of the cooled water into the HSA 406 at the injection depth D_{I} responsive to the modified third control signal.

As shown by magnified view 470, the HSA 406 may include a plurality of channels that permit water within the HSA 406 to flow through the HSA 406 from the injection well 412 to the extraction well 420, as shown by reference arrow 450. During operation, the injection well 412 can be used to release a certain amount of cooled water at the injection depth D_{I} in a region of the HSA 406, and the extraction well 420 can be used to harvest heated water in another region of the HSA 406. Accordingly, as indicated by temperature scale 460 and the shading of channels shown in the magnified view 472 of the HSA 406, the temperature of the water flowing vertically between in the injection well 412 and the extraction well 420 can be relatively cooler toward the injection well 412 and relatively warmer toward the extraction well 420 due to the configuration of the NAT-EGS 400 and geothermal characteristics of the HSA 406. Correspondingly, as illustrated by the shading of the reference arrow 450, the water in the HSA 406 can be heated as the water permeates or flows vertically from the injection depth D_{I} to the extraction depth D_{E}.

Using the NAT-EGS 400, water can be cycled through the HSA 406. For example, injected cooled water in a first region of the HSA 406 can be exposed to heated material (e.g., sand, rocks, and/or the like) and the heated water within the HSA 406. More specifically, as the cooled water traverses or is infused within the HSA 406, the cooled water is warmed via conduction, convection, advection, or a combination thereof. As heated water is pumped from the extraction well 420 in a second region of the. HSA 406, the injected water permeates vertically to replace the extracted water. As the energy or heat is harvested from the extracted water, which is now relatively cooler, the cooled water is then reinjected into the first region of the HSA 406 via the injection well 412. That cooled water can again be heated and migrate vertically, mingling with other waters eventually to be harvested throughout one or more cycles. By this technique, a large-scale convective or circulation system can be established within the greater surrounding HSA 406 environment between the extraction well 420, the power plant 410, the injection well 412, and the HSA 406. As a result, in the NAT-EGS 400, heat is provided mainly by widespread, natural advection or convection of super-heated water in the deep sedimentary aquifer over a volume of the HSA 406 material surrounding the specific wells and thus a longer (e.g., greater than 40 years) and more continuous production of energy can be maintained substantially without the potential of environmental hazard (e.g., from fracking techniques).

In some embodiments, the NAT-EGS 400 may have a longer useful life (e.g., over 40 years or more) due to the geothermal characteristics of the HSA 406. Further, the NAT-EGS 400 may be substantially maintenance free during the extended duration and useful life of the NAT-EGS 400 because the heat source (e.g., the HSA 406) does not have to be maintained (e.g., no fractures may need to be cleared of debris and/or reopened to maintain a desired flow if the fractures collapse). Moreover, within the source volume of the HSA 406 (e.g., vertically between the drill holes), there are no pipes or artificial or manufactured pathways that may need maintenance.

In some embodiments, the NAT-EGS 400 can provide a large-scale convective thermal recharge of the HSA 406 via circulatory movement of water and heat through the. HSA 406 that is induced by the pressure field and temperature gradient associated with pumping water from the extraction well 420 and back into the HSA 406 via the injection well 412. For example, water from areas that are not within regions surrounding the wells can be pulled into the heat zone between the wells via the circulatory movement, Thus, water in regions of the HSA 406 around the wells can be continuously reheated by the higher temperature of sedimentary rocks throughout the HSA 406, Furthermore, a combined effect of heated, low density water being extracted from one region of the HSA 406, and cooled denser water, having been run through the power plant, being injected into another region of the HSA 406 functions, in effect, as a thermal flywheel to sustain the circulation.

FIGS. 5A and 5B are schematic diagrams of an implementation of a thin-bed NAT-EGS 500 (e.g., a thin-bed GPC) in a thin sedimentary aquifer, according to some embodiments. In some aspects, the thin-bed NAT-EGS 500, or any portion thereof can be implemented using any of the structures, components, features, or techniques described with reference to the geothermal system 100 described with reference to FIG. 1; the well pair 200 described with reference to FIG. 2; the RAD-EGS 300 described with reference to FIG. 3; the NAT-EGS 400 described with reference to FIG. 4; the multi-well geothermal system 600 described with reference to FIG. 6; the method 700 described with reference to FIG. 7; the method 800 described with reference to FIG. 8; the computer system 900 described x-with reference to FIG. 9; any other suitable structure, component, feature, or technique; any portion thereof; or any combination thereof. In some embodiments, one or more of the operations described below with reference to FIGS. 5A and 5B may be performed or otherwise carried out by one or more components of the computer system 900.

As shown in FIG. 5A, the thin-bed NAT-EGS 500 can include a power plant 510 that includes a power generation unit, a pump system, a well system disposed within a thin-bed HSA 506, and a regulatory device. In some embodiments, the thin-bed HSA 506 can be disposed above an impermeable rock 507. The thin-bed HSA 506 can be identified or selected based on a convective heat transfer coefficient of the thin-bed HSA 506 satisfying a threshold convective heat transfer coefficient (e.g., based on a pressure-driven, dipole-driven, and/or temperature-driven convective flow of water through the thin-bed HSA 506, or a combination thereof, as described above with reference to FIGS. 1-2 and/or below with reference to FIGS. 7-8). In some embodiments, a thickness T_{HSA} of the thin-bed HSA 506 can be, for example, equal to or less than about 100 meters.

The well system can include an extraction well 520 that enables the pump system to provide heated water at an extraction depth D_{E} of the thin-bed HSA 506 to the power generation unit. The extraction well 520 can include a production element that includes an extraction pump, an extraction lateral 518 disposed within the thin-bed HSA 506 at the extraction depth D_{E}, and a vertical extraction component 519 extending between the extraction depth D_{E} and the power generation unit of the power plant 510.

The well system can further include an injection well 512 that enables the pump system to inject cooled water from the power generation unit into the thin-bed HSA 506 at an injection depth D_{I}. The injection well 512 can include an injection element that includes an injection pump, an injection lateral 514 disposed within the thin-bed HSA 506 at the injection depth D_{I} and a vertical injection component 513 extending between the injection depth D_{I} and the power generation unit of the power plant 510.

In some embodiments, when the thickness nisi of the thin-bed HSA 506 is not adequately thick, the extraction lateral 518 and the injection lateral 514 can be located horizontally offset from each other to generate a fluid convection or recirculation system within the thin-bed HSA 506. In such embodiments, a horizontal distance 523 (e.g., along the Y-axis as shown in FIG. 5A) between the extraction lateral 518 and the injection lateral 514 can be substantially non-zero. For example, the horizontal distance 523 between the injection lateral 514 and the extraction lateral 518 can be equal to or greater than about 300 meters. In another example, the horizontal distance 523 between the extraction lateral 518 and the injection lateral 514 can be equal to or greater than about 500 meters.

In some embodiments, a depth difference ΔD between the extraction depth D_{E} and the injection depth D_{I} (where ΔD=|D_{I}<D_{E}|) can be equal to or less than about the thickness T_{HSA} of the thin-bed HSA 506 (e.g., ΔD can be less than or equal to about 100 meters, 75 meters, 50 meters, 55 meters, 10 meters, etc.). In some aspects, the thickness T_{HSA} of the thin-bed HSA 506 can be equal to or less than about 50 meters, and the depth difference ΔD between the extraction depth. D_{E} and the injection depth D_{I} can be equal to or less than about the thickness T_{HSA} of the thin-bed HSA 506 (e.g., ΔD can be less than or equal to about 50 meters, 40 meters, 30 meters, 50 meters, 10 meters, etc.). In some aspects, the depth difference ΔD may be determined according to the geothermal characteristics of the thin-bed HSA 506 and may be on the order of 100 meters or less.

In some embodiments, as shown in FIG. 5A, the injection depth D_{I} can be substantially the same as the extraction depth D_{E}. In other embodiments, the injection depth D_{I} can be substantially deeper than the extraction depth D_{E}. In still other embodiments, depending upon the terrain, the extraction depth D_{E} can be deeper than the injection depth D_{I}. In such embodiments, where the depth difference ΔD between the extraction depth D_{E} and the injection depth D_{I} is substantially non-zero, the configuration of the injection well 512 and the extraction well 520 (which may be referred to collectively herein as “the wells'”) can be “disjointed” in that the wells can be drilled to different depths substantially without creating manmade fractures or openings directly connecting the wells (e.g., between the extraction lateral 518 of the extraction well 520 and the injection lateral 514 of the injection well 512). For example, the terrain of the thin-bed HSA 506 between the injection well 512 and the extraction well 520 can have a sufficient permeability to create a substantially uninhibited lateral flow of water between the wells, as indicated by reference arrow 550.

The regulatory device can be configured to generate a first control signal configured to instruct the pump system to pump, via the extraction well 520, the heated water from the thin-bed HSA 506 at the extraction depth D_{E} to the power generation unit. In some embodiments, the first control signal can be further configured to instruct the pump system to pump, via the extraction well 520, the heated water from the thin-bed HSA 506 at the extraction depth D_{E} at an extraction rate that stimulates a convective flow field (e.g., convective flow field 551 described with reference to FIG. 5B). The convective flow field can include, for example, a convective heat transfer rate that satisfies a threshold convective heat transfer rate that provides a convective thermal recharge of the extracted heat. In some embodiments, the regulatory device can be further configured to generate a second control signal configured to instruct the power generation unit to extract heat from the heated water to generate power and transform the heated water into the cooled water. In some embodiments, the regulatory device can be further configured to generate a third control signal configured to instruct the pump system to pump, via the injection well 512, the cooled water from the power generation unit into the thin-bed HSA 506 at the injection depth D_{I}. In some embodiments, the third control signal can be further configured to instruct the pump system to pump, via the injection well 512, the cooled water into the thin-bed HSA 506 at the injection depth D_{I} at an injection rate that further stimulates the convective flow field.

In some embodiments, the third control signal can be further configured to instruct the pump system to inject the cooled water with a supplemental agent to stimulate the convective flow of water through the thin-bed HSA 506. The supplemental agent can include, for example, a solvent or solute (e.g., muriatic acid, hydrochloric acid), any other suitable agent, or any combination thereof. When injected into the thin-bed HSA 506 via the injection well 512 (e.g., along with the cooled water), the supplemental agent can increase the permeability, porosity, and/or convective heat transfer coefficient of the thin-bed HSA 506 (e.g., by causing erosion or breakdown of some of the rock or material of the thin-bed HSA 506). In this way, the thin-bed NAT-EGS 500, using the supplemental agent, can improve geothermal energy extraction via the thin-bed HSA 506.

In some embodiments, the well system can be configured to stimulate the convective flow field within the thin-bed HSA 506 based on a first pumping of the heated water from the thin-bed HSA 506 at the extraction depth D_{E} responsive to the first control signal and further based on a second pumping of the cooled water into the thin-bed HSA 506 at the injection depth D_{I} responsive to the third control signal. In some embodiments, the regulatory device can be configured to modify the first control signal, the second control signal, the third control signal, or a combination thereof based on measurements of the convective flow field obtained by instrumentation devices disposed on the extraction lateral 518 and the injection lateral 514 (e.g., as described with reference to FIG. 2). In such aspects, the well system can be configured to modify the stimulation of the convective flow field within the thin-bed HSA 506 based on a modified first pumping of the heated water from the thin-bed HSA 506 at the extraction depth D_{E} responsive to the modified first control signal and further based on a modified second pumping of the cooled water into the thin-bed HSA 506 at the injection depth D_{I} responsive to the modified third control signal.

As shown by magnified view 570, the thin-bed HSA 506 may include a plurality of channels that permit water within the thin-bed HSA 506 to flow through the thin-bed HSA 506 from the injection well 512 to the extraction well 520, as shown by reference arrow 550. During operation, the injection well 512 can be used to release a certain amount of cooled water at the injection depth D_{I} in a region of the thin-bed HSA 506, and the extraction well 520 can be used to harvest heated water in another region of the thin-bed HSA 506. Accordingly. as indicated by temperature scale 560 and the shading of channels shown in magnified view 570 of the thin-bed HSA 506, the temperature of the water flowing laterally between in the injection well 512 and the extraction well 520 can be relatively cooler toward the injection well 512 and relatively warmer toward the extraction well 520 due to the configuration of the thin-bed NAT-ECUS 500 and geothermal characteristics of the thin-bed HSA 506. Correspondingly, as illustrated by the shading of the reference arrow 550, the water in the thin-bed HSA 506 can be heated as the water permeates or flows laterally from the injection depth D_{I} to the extraction depth D_{E}.

Using the thin-bed NAT-EGS 500, water can be cycled through the thin-bed HSA 506. For example, injected cooled water in a first region of the thin-bed HSA 506 can be exposed to heated material (e.g., sand, rocks, and/or the like) and the heated water within the thin-bed HSA 506. More specifically, as the cooled water traverses or is infused within the thin-bed HSA 506, the cooled water is warmed via conduction, convection, advection, or a combination thereof. As heated water is pumped from the extraction well 520 in a second region of the thin-bed HSA 506, the injected water circulates within the thin-bed HSA 506 to replace the extracted water. As the energy or heat is harvested from the extracted water, which is now relatively cooler, the cooled water is then reinjected into the first region of the thin-bed HSA 506 via the injection well 512. That cooled water can again be heated as it circulates and mingles with other waters eventually to be harvested throughout one or more cycles. By this technique, a large-scale convective or circulation system can be established within the greater surrounding thin-bed HSA 506 environment between the extraction well 520, the power plant 510, the injection well 512, and the thin-bed HSA 506. As a result, in the thin-bed NAT-EGS 500, heat is provided mainly by widespread, natural advection or convection of super-heated water in the deep sedimentary aquifer over a volume of the thin-bed HSA 506 material surrounding the specific wells and thus a longer (e.g., greater than 50 years) and more continuous production of energy can be maintained substantially without the potential of environmental hazard (e.g., from fracking techniques).

In some embodiments, the thin-bed NAT-EGS 500 may have a longer useful life (e.g., 10-20 years, or even over 50 years or more) due to the geothermal characteristics of the thin-bed HSA 506 (many of which are located throughout the Earth). Further, the thin-bed NAT-EGS 500 may be substantially maintenance free during the extended duration and useful life of the thin-bed NAT-EGS 500 because the heat source (e.g., the thin-bed HSA 506) does not have to be maintained (e.g., no fractures may need to be cleared of debris and/or reopened to maintain a desired flow if the fractures collapse). Moreover, within the source volume of the thin-bed HSA 506 (e.g., laterally between the drill holes), there are no pipes or artificial or manufactured pathways that may need maintenance.

In some embodiments, the thin-bed NAT-EGS 500 can provide a large-scale convective thermal recharge of the thin-bed HSA 506 via circulatory movement of water and heat through the thin-bed HSA 506 that is induced by the pressure field and temperature gradient associated with pumping water from the extraction well 520 and back into the thin-bed HSA 506 via the injection well 512. For example, water from areas that are not within regions surrounding the wells can be pulled into the heat zone between the wells via the circulatory movement. Thus, water in regions of the thin-bed HSA 506 around the wells can be continuously reheated by the higher temperature of sedimentary rocks throughout the thin-bed HSA 506. Furthermore, a combined effect of heated, low density water being extracted from one region of the thin-bed HSA 506, and cooled denser water, having, been run through the power plant, being injected into another, region of the thin-bed HSA 506 functions, in effect, as a thermal flywheel to sustain the circulation.

FIG. 5B illustrates the results of a numerical simulation 501 of the full operation of the thin-bed NAT-EGS 500 shown in FIG. 5A utilizing an example numerical modeling domain, according to some embodiments. As shown in FIG. 5B, the thin-bed NAT-EGS 500 can include an extraction well 520 having a production element that includes an extraction pump, a vertical extraction component 519, and an extraction lateral 518 laterally drilled at an extraction depth and disposed within a thin-bed HSA 506. The thin-bed NAT-EGS 500 can further include an injection well 512 having an injection element that includes an, injection pump, a vertical injection component 513, and an injection lateral 514 laterally drilled at an injection depth and disposed within the thin-bed HSA 506. The thin-bed HSA 506 can be disposed below a confining layer 505 and above an impermeable rock 507. The geophysical characteristics of each of the confining layer 505, the thin-bed HSA 506 and the impermeable rock 507 have been determined via geologic data analysis.

As further shown in FIG. 5B, the results of the example numerical simulation of the full operation of the thin-bed NAT-EGS 500 show a convective flow field 551 (e.g., a convective recirculation cell) induced within the thin-bed HSA 506. In this numerical simulation, the thin-bed HSA 506 was about 50 meters and located at a depth of about 2,800 meters below the surface, the extraction well 520 and the injection well 512 were parallel to each other, and the horizontal distance 523 between the extraction lateral 518 and the injection lateral 514 was 300 meters. Due to a dipolar pumping pressure, the convective flow field 551 was formed which caused an aquifer-wide mixing of the injected water and existing water. Such convection caused recharging of the system and increased the longevity of the thin-bed NAT-EGS 500. The arrows and lines in the convective how field 551 were calculated (e.g., extrapolated) values and showed that the convective flow field 551 was still operating after 20 years as long as pumping is in effect. In some embodiments, the convective heat transfer coefficient of the thin-bed HSA 506 can be determined based on the convective flow field 551. In some embodiments, the regulatory device can be configured to modify the first control signal, the second control signal, the third control signal, or a combination thereof based on a comparison of the convective flow field 551 to the measurements of the stimulated convective flow field in the thin-bed HSA 506 obtained by instrumentation devices disposed on the extraction lateral 118 and the injection lateral 114.

FIG. 6 is a schematic diagram of an overhead view of an implementation of a multi-well geothermal system 600 having multiple underground lateral well pairs disposed below a power plant 510, according to some embodiments. In some aspects, the multi-well geothermal system 600, or any portion thereof, can be implemented using any of the structures, components, features, or techniques described with reference to the geothermal system 100 described with reference to FIG. 1; the well pair 200 described with reference to FIG. 2; the RAD-EGS 300 described with reference to FIG. 3; the NAT-EGS 400 described with reference to FIG. 4; the thin-bed NAT-EGS 500 described with reference to FIGS. 5A and 5B; the method 700 described with reference to FIG. 7; the method 800 described with reference to FIG. 8; the computer system 900 described with reference to FIG. 9; any other suitable structure, component, feature, or technique; any portion thereof; or any combination thereof. In some embodiments, one or more of the operations described below with reference to FIG. 6 may be performed or otherwise carried out by one or more components of the computer system 900.

As shown in FIG. 6, the multiple extraction wells and the multiple injection wells can include, but are not limited to, extraction wells 618A-618I and injection wells 614A-614I, respectively. As further shown in FIG. 6, the multiple extraction wells and the multiple injection wells may be formed according to a wagon-wheel pattern. Additionally or alternatively, the multiple extraction wells and the multiple injection wells may be formed according to a wine-rack pattern, a gun-barrel pattern, a chicken-foot pattern, a vertically-stacked pattern, any other suitable pattern or arrangement, or any combination thereof.

In some embodiments, the power plant 510 can generate a power output of about 25 to 500 megawatts by extracting heated water from an HSA and/or vane system via the multiple extraction wells, extracting heat from the heated water to capture energy, resulting in cooled water, and re-injecting the cooled water back into the HSA and/or vane system via the multiple injection wells. The HSA and/or vane system can be identified or selected based on a respective convective heat transfer coefficient of each respective region of the HSA or vane associated with a respective well pair satisfying a respective threshold convective heat transfer coefficient (e.g., based on a gravity-driven, pressure-driven, dipole-driven, and/or temperature-driven convective flow of water through the HSA and/or vanes, or a combination thereof, as described above with reference to FIGS. 1-2 and/or below with reference to FIGS. 7-8).

As shown in FIG. 6, the multi-well geothermal system 600 can include a power plant 610 that includes a power generation unit, a pump system, and a well system disposed within an HSA (e.g., an HSA or a thin-bed HSA as described with reference to FIGS. 1, 4, 5A, and 5B) or a system of vanes (e g., as described with reference to FIG. 3). In some embodiments, the HSA and/or vanes can be disposed above an impermeable rock.

The well system can include multiple extraction wells, such as the extraction wells 618A-618I, that enable the pump system to provide heated water at one or more extraction depths of the HSA and/or vanes to the power generation unit. Each of the extraction wells 618A-618I can include a production element that includes an extraction pump, an extraction lateral disposed within the HSA or a respective vane at a respective one of the one or more extraction depths, and a vertical extraction component connecting the respective extraction lateral to the power generation unit.

The well system can further include multiple injection wells, such as the injection wells 614A-6141, that enable the pump system to inject cooled water from the power generation unit into the HSA and/or vanes at one or more injection depths. Each of the injection wells 614A-614I can include an injection element that includes an injection pump, an injection lateral disposed within the HSA or a respective vane at a respective one of the one or more injection depths, and a vertical injection component connecting the respective injection lateral to the power generation unit.

As shown in FIG. 6, the extraction wells 618A-618I and the injection wells 614A-614I may be formed according to a wagon-wheel pattern. For example, a first pair of wells can include the extraction well 618A and the injection well 614A whose laterals are disposed within a first region of the HSA or a first vane. A second pair of wells can include the extraction well 618B and the injection well 614B whose laterals are disposed within a second region of the HSA or a second vane, A third pair of wells can include the extraction well 618C and the injection well 614C whose laterals are disposed within a third region of the HSA or a third vane. A fourth pair of wells can include the extraction well 618D and the injection well 614D whose laterals are disposed within a fourth region of the HSA or a fourth vane. A fifth pair of wells can include the extraction well 618E and the injection well 614E whose laterals are disposed within a fifth region of the HSA or a fifth vane. A sixth pair of wells can include the extraction well 618I and the injection well 614F whose laterals are disposed within a sixth region of the HSA or a sixth vane. A seventh pair of wells can include the extraction well 618E and the injection well 614G whose laterals are disposed within a seventh region of the HSA or a seventh vane. An eighth pair of wells can include the extraction well 618H and the injection well 614H whose laterals are disposed within an eighth region of the HSA or an eighth vane. A ninth pair of wells can include the extraction well 618I and the injection well 614I whose laterals are disposed within a ninth region of the HSA or a ninth vane.

The well system can further include a regulatory device configured to generate a set of first control signals configured to instruct the pump system to pump the heated water from the extraction wells 618A-618Ito the power generation unit. In some embodiments, the set of first control signals, can be further configured to instruct the pump system to pump, via the extraction wells 618A-618I, the heated water from the one or more extraction depths of the HSA and/or vanes at one or more extraction rates that stimulate a convective flow field. The convective flow field can include, for example, one or more convective heat transfer rates that satisfy one or more threshold convective heat transfer rates that provide a convective thermal recharge of the heat extracted from the HSA and/or vanes. The regulatory device can be further configured to generate a second control signal configured to instruct the power generation unit to extract thermal energy from the heated water and to transform the heated water into cooled water. The regulatory device can be further configured to generate a set of third control signals configured to instruct the pump system to pump, via the injection wells 614A-614I, the cooled water from the power generation unit into the HSA and/or vanes at the one or more injection depths at one or more injection rates that further stimulate the convective flew field.

In some embodiments, the set of third control signals can be further configured to instruct the pump system to inject, via the injection wells 614A-614I, the cooled water with a supplemental agent to enhance a permeability, a porosity, and/or a convective heat transfer coefficient of the HSA and/or vanes. The supplemental agent can include a solute or solvent, including, but not limited to, a muriatic acid, a hydrochloric acid, and/or any other materials and methods to enhance the convective heat transfer coefficient of the HSA and/or vanes. When injected into the HSA and/or vanes via the injection wells 614A-614I (e.g., along with the cooled water), the supplemental agent can increase the permeability, porosity, and/or convective heat transfer coefficient of the HSA and/or vanes (e.g., by causing erosion or breakdown of some of the rock or material of the HSA and/or vanes). For example, the convective heat transfer coefficient may not satisfy a threshold convective heat transfer coefficient before an injection of the cooled water with the supplemental agent, and the convective heat transfer coefficient can satisfy the threshold convective heat transfer coefficient after the injection of the cooled water with the supplemental agent. In this way, the multi-well geothermal system 600, using the supplemental agent, can improve geothermal energy extraction via the HSA and/or vanes.

In some embodiments, the well system can be configured to stimulate the convective flow field within the HSA and/or vane system based on a first pumping of the heated water from the HSA and/or vanes responsive to the first set of control signals and further based on a second pumping of the cooled water into the HSA and/or vanes responsive to the set of third control signals. In some embodiments, the regulatory device can be configured to modify the first set of control signals, the second control signal, the set of third control signals, or a combination thereof based on measurements of the convective flow field obtained by instrumentation devices disposed on the extraction wells 618A-618I and the injection wells 614A-614I (e.g., as described with reference to FIG. 2). In such aspects, the well system can be configured to modify the stimulation of the convective flow field within the HSA and/or vanes based on a modified first pumping of the heated water from the HSA and/or vanes at the extraction depth D_{E} responsive to the modified first set of control signals and further based on a modified second pumping of the cooled water into the HSA and/or vanes at the injection depth D_{I} responsive to the modified set of third control signals.

In some embodiments, the multi-well geothermal system 600 can provide a large-scale convective thermal recharge of the HSA and/or vanes via circulatory movement of water and heat through the HSA and/or vanes that is induced by the pressure field and temperature gradient associated with pumping water from the extraction wells 618A-618I and back into the HSA and/or vanes via the injection wells 614A-614I. For example, water from areas that are not within regions surrounding each pair of wells can be pulled into the heat zone between the pair of wells via the circulatory movement. Thus, water in regions of the HSA and/or vanes around the well pairs can be continuously reheated by the higher temperature of sedimentary rocks throughout the HSA and or vane system.

In some embodiments, the power plant 610 can generate a power output of about 25 to 500 megawatts. For example, the power generation unit of the power plant 610 may generate a power output of about 20 megawatts using only the extraction well 618A and the injection well 614A. In contrast, the power generation unit of the power plant 610 may generate a power output of about 25 to 500 megawatts using the extraction wells 618A-618I and the injection wells 614A-614I as described herein.

### Example Method for Configuring a Geothermal System

FIG. 7 is a flowchart for a method 700 for configuring a geothermal system, according to an embodiment. Method 700 can be performed by processing logic that can include hardware (e.g., circuitry, dedicated logic, programmable logic, microcode, etc.), software (e.g., instructions executing on a computing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIG. 1. However, method 700 is not limited to those example embodiments. For example, while the method 700 refers to the HSA 106, in other embodiments, the method 800 can refer to the vane 306, the HSA 406, or the thin-bed HSA 506.

In 702, the method 700 includes identifying an HSA 106 below a surface location of a surface 102 and having a convective heat transfer coefficient that satisfies a threshold convective heat transfer coefficient. The convective heat transfer coefficient of the HSA 106 can be indicative of free convection, forced convection, or both resulting from the motion of fluid water; water mixed with a supplemental agent) within the HSA 106 (e g., as indicated by the water flow 116). In some embodiments, the identifying the convective heat transfer coefficient can include identifying the HSA 106 according to an analysis of geologic data associated with the HSA 106 that provides for sufficient convective thermal recharge of the HSA 106.

In 704, the method 700 includes determining, based on a geothermal characteristic of the HSA 106 that satisfies a threshold associated with providing geothermal energy, an extraction depth D_{E} for an extraction well 120 disposed to extract heated water from the HSA 106. In 704, the method 700 further includes determining, based on the geothermal characteristic, an injection depth D_{I} for an injection well 112 disposed to inject cooled water into the HSA 106 that is generated from a heat extraction process (e.g., performed by the power plant 610) associated with capturing the geothermal energy.

In some embodiments, the extraction well 120 can include an extraction lateral 118 disposed at the extraction depth D_{E}, and the injection well 112 can include an injection lateral 114 disposed at the injection depth D_{I}. In some embodiments, a depth difference ΔD between the extraction depth D_{E} of the extraction lateral 118 and the injection depth D_{I} of the injection lateral 114 can be based on the geothermal characteristic. For example, the depth difference ΔD can be equal to or less than about the thickness T_{HSA} of the HSA 106, which, in some aspects, can be equal to or less than about 100 meters. Additionally or alternatively, in some embodiments, the horizontal distance (e.g., along the Y-axis as shown in FIG. 1) between the extraction lateral 118 and the injection lateral 114 can be based on the geothermal characteristic. For example, the horizontal distance between the extraction lateral 118 and the injection lateral 114 can be equal to or greater than about 300 meters.

In 706, the method 700 includes configuring the geothermal system 100 to extract, the heated water from the HSA 106 at the extraction depth Dr. Optionally, the method 700 can further include configuring, the geothermal system 100 to pump, via the extraction well 120, the heated water from the HSA 106 at the extraction depth D_{E} at an extraction rate that stimulates a convective flow field that provides a recharge of the HSA 106. For example, the convective flow field can include a convective heat transfer rate that satisfies a threshold convective heat transfer rate sufficient to provide a convective thermal recharge of the heat extracted from the heated water by the heat extraction process (e.g., to provide a decades-long longevity of the extracted heat for geothermal power generation).

In 708, the method 700 includes configuring the geothermal system 100 to inject cooled water into the HSA 106 at the injection depth D_{I}. Optionally, the method 700 can further include configuring the geothermal system 100 to inject, via the injection well 112, the cooled water into the HSA 106 at the injection depth D_{I} at an injection rate that further stimulates the convective flow field.

In some embodiments, the configuring the geothermal system 100 in 708 can include configuring the geothermal system 100 to inject, via the injection well 112, the cooled water with a supplemental agent to increase the convective heat transfer coefficient of the HSA 106 (e.g., by enhancing the permeability of the HSA 106). The supplemental agent can include, for example, such materials as or similar to a muriatic acid and a hydrochloric acid. In such embodiments, before the injecting the cooled water with the supplemental agent, the convective heat transfer coefficient may not satisfy the threshold convective heat transfer coefficient, and after the injecting the cooled water with the supplemental agent, the convective heat transfer coefficient may satisfy the threshold convective heat transfer coefficient.

Optionally, the method 700 can further include configuring the geothermal system 100 to stimulate a convective flow field within the HSA 106 based on an extraction of the heated water from the HSA 106 at the extraction depth D_{E} and an injection of the cooled water into the HSA 106 at the, injection depth D_{I}.

In some embodiments, the convective heat transfer within the HSA 106 can be indicative of free convection based on a gravity-driven convective flow of water through the HSA 106 induced by a gravitational field within the HSA 106. For example, the extraction lateral 118 of the extraction well 120 can be disposed within a first region of the HSA 106, the injection lateral 114 of the injection well 112 can be disposed within a second region of the HSA 106, and a depth difference ΔD (e.g., vertical distance 122) between the extraction depth D_{E} of the extraction lateral 118 and the injection depth of the injection lateral 114 can be equal to or greater than a threshold depth distance that provides, based on the gravity-driven convective flow of the water through the HSA 106, a convective heat transfer rate within the HSA 106 that satisfies a threshold convective heat transfer rate sufficient to provide a convective thermal recharge of the heat extracted from the heated water by the heat extraction process.

In some embodiments, the convective heat transfer within the HSA 106 can be indicative of free convection based on a pressure-driven convective flow of water through the HSA 106 induced by a natural pressure gradient within the HSA 106. For example, the natural pressure gradient can be equal to or greater than a threshold natural pressure gradient that provides, based on the pressure-driven convective flow of the water through the HSA 106, a convective heat transfer rate within the HSA 106 that satisfies a threshold convective heat transfer rate sufficient to provide a convective thermal recharge of the heat extracted from the heated water by the heat extraction process.

In some embodiments, the convective heat transfer within the HSA 106 can be indicative of forced convection based on a convective flow of water through the HSA 106 induced by a dipolar pressure gradient formed within the HSA 106 in response to pumping the heated water from the HSA 106 at the extraction depth D_{E} and injecting the cooled water into the HSA 106 at the injection depth D_{I}. For example, the dipolar pressure gradient can be equal to or greater than a threshold dipolar pressure gradient that provides, based on the dipole-driven convective flow of the water through the HSA 106, a convective heat transfer rate within the HSA 106 that satisfies a threshold convective heat transfer rate sufficient to provide a convective thermal recharge of the heat extracted from the heated water by the heat extraction process.

In some embodiments, the convective heat transfer within the HSA 106 can be indicative of free convection based on a temperature-driven convective flow of water through the HSA 106 induced by a temperature gradient formed within the HSA 106 in response to pumping the heated water from the HSA 106 at the extraction depth D_{E} and injecting the cooled water into the HSA 106 at the injection depth D_{I}. For example, the temperature gradient can be equal to or greater than a threshold temperature gradient that provides, based on the temperature-driven convective flow of the water through the HSA 106, a convective heat transfer rate within the HSA 106 that satisfies a threshold convective heat transfer rate sufficient to provide a convective thermal recharge of the heat extracted from the heated water by the heat extraction process.

In some embodiments, the convective heat transfer within the HSA 106 can include a multi-mode heat transfer within the HSA 106 indicative of two or more of a gravity-driven convective flow of water through the HSA 106 induced by a gravitational field within the HSA 106; a pressure-driven convective flow of water through the HSA 106 induced by a natural pressure gradient within the HSA 106; a convective flow of water through the HSA 106 induced by a dipolar pressure gradient formed within the HSA 106 based on the pumping the heated water from the extraction depth and the injecting the cooled water at the injection depth; and a temperature-driven convective flow of water through the HSA 106 induced by a temperature gradient formed within the HSA 106 based on the pumping the heated water from the extraction depth and the injecting the cooled water at the injection depth. For example, the convective heat transfer within the HSA 106 can be indicative of a convective flow of water through the HSA 106 induced by thermal gradients and gravitational fields within the HSA 106.

### Example Method for Harvesting Heat from a Hot Sedimentary Aquifer

FIG. 8 is a flowchart for a method 800 for harvesting heat from an HSA, according to an embodiment. Method 800 can be performed by processing logic that can include hardware (e.g., circuitry, dedicated logic, programmable logic, microcode, etc.), software (e.g., instructions executing on a computing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to FIG. 1. However, method 800 is not limited to those example embodiments. For example, while the method 800 refers to the HSA 106, in other embodiments, the method 800 can refer to the vane 306, the HSA 406, or the thin-bed HSA 506.

In 802, the method 800 includes pumping, via an extraction well 120 of a geothermal system 100, heated water from an extraction depth D_{E} Of an HSA 106. The pumping the heated water can include, for example, pumping the heated water via a production element and an extraction lateral 118 of the extraction well 120. The production element can include an extraction pump and a vertical extraction component 119 extending between the extraction depth D_{E} and the power generation unit. The extraction lateral 118 can be mechanically coupled to the production element and include one or more lateral production branches that extend from the production element at the extraction depth D_{E}.

In 804, the method 800 includes extracting, via a power generation unit of the geothermal system 100, heat from the heated water to generate power and transform the heated water into cooled water.

In 806, the method 800 includes injecting, via an injection well 112 of the geothermal system 100, the cooled water at an injection depth D_{I} of the HSA 106. The injecting of the cooled water can include, for example, injecting the cooled water via an injection element and an injection lateral 114 of the injection well 112. The injection element can include an injection pump and a vertical injection component 113 extending between the injection depth D_{I} and the power generation unit. The injection lateral 114 can be mechanically coupled to the injection element and include one or more lateral injection branches that extend from the injection element at the injection depth D_{I}.

In some embodiments, a depth difference ΔD between the extraction depth D_{E} of the extraction lateral 118 and the injection depth lar of the injection lateral 114 can be equal to or less than about the thickness T_{HSA} of the HSA 106, which, in some aspects, can be equal to or less than about 100 meters. Additionally or alternatively, in some embodiments, the horizontal distance (e.g., along the Y-axis as shown in FIG. 1) between the extraction lateral 118 and the injection lateral 114 can be equal to or greater than about 300 meters.

In some embodiments, the HSA 106 can be identified or selected based on a convective heat transfer coefficient of the HSA 106 satisfying a threshold convective heat transfer coefficient. The convective heat transfer coefficient of the HSA 106 can be indicative of free convection, forced convection, or both resulting from the motion of fluid (e.g., water; water mixed with a supplemental agent) within the HSA 106 (e.g., as indicated by the water flow 116). In some embodiments, the convective heat transfer within the HSA 106 can be determined according to an analysis of geologic data associated with the HSA 106 that provides for sufficient convective thermal recharge of the heat extracted in 804.

In some embodiments, the convective heat transfer within the HSA 106 can be indicative of free convection based on a gravity-driven convective flow of water through the HSA 106 induced by a gravitational field within the HSA 106. For example, the extraction lateral 118 of the extraction well 120 can be disposed within a first region of the HSA 106, the injection lateral 114 of the injection well 112 can be disposed within a second region of the HSA 106, and a depth difference ΔD vertical distance 122) between the extraction depth D_{E} of the extraction lateral 118 and the injection depth D_{I} of the injection lateral 11.4 can be equal to or greater than a threshold depth distance that provides, based on the gravity-driven convective flow of the water through the HSA 106, a convective heat transfer rate within the HSA 106 that satisfies a threshold convective heat transfer rate sufficient to provide a convective thermal recharge of the heat extracted in 804.
In some embodiments, the convective heat transfer within the HSA 106 can be indicative of free convection based on a pressure-driven convective flow of water through the HSA 106 induced by a natural pressure gradient within the HSA 106. For example, the natural pressure gradient can be equal to or greater than a threshold natural pressure gradient that provides, based on the pressure-driven convective flow of the water through the HSA 106, a convective heat transfer rate within the HSA 106 that satisfies a threshold convective heat transfer rate sufficient to provide a convective thermal recharge of the heat extracted in 804.

In some embodiments, the convective heat transfer within the HSA 106 can be indicative of forced convection based on a convective flow of water through the HSA 106 induced by a dipolar pressure gradient formed within the HSA 106 based on the pumping the heated water in 802 and the injecting the cooled water in 806. For example, the dipolar pressure gradient can be equal to or greater than a threshold dipolar pressure gradient that provides, based on the dipole-driven convective flow of the water through the HSA 106, a convective heat transfer rate within the HSA 106 that satisfies a threshold convective heat transfer rate sufficient to provide a convective thermal recharge of the heat extracted in 804.

In some embodiments, the convective heat transfer within the HSA 106 can be indicative of free convection based on a temperature-driven convective flow of water through the HSA 106 induced by a temperature gradient formed within the HSA 106 based on the pumping the heated water in 802 and the injecting the cooled water in 806. For example, the temperature gradient can be equal to or greater than a threshold temperature gradient that provides, based on the temperature-driven convective flow of the water through the HSA 106, a convective heat transfer rate within the HSA 106 that satisfies a threshold convective heat transfer rate sufficient to provide a convective thermal recharge of the heat extracted in 804.

In some embodiments, the method 800 can further include stimulating a convective flow field within the HSA 106 based on the pumping the heated water in 802 and the injecting the cooled water in 806. The convective flow field can include a convective heat transfer rate that satisfies a threshold convective heat transfer rate sufficient to provide a convective thermal recharge of the heat extracted in 804 (e.g., to provide a decades-long longevity of the extracted heat for geothermal power generation). For example, the pumping the heated water in 802 can include pumping, via the extraction well 120, the heated water from the HSA 106 at the extraction depth D_{E} at an extraction rate that stimulates the convective flow field. In another example, the injecting the cooled water in 806 can include injecting, via the injection well 112, the cooled water at the injection depth D_{I} at an injection rate that stimulates the convective flow field. In yet another example, the injecting of the cooled water in 806 can include injecting, via the injection well 112, the cooled water with a supplemental agent to increase the convective heat transfer coefficient of the HSA 106 (e.g., by enhancing the permeability of the HSA 106). The supplemental agent can include, for example, such materials as or similar to a muriatic acid and a hydrochloric acid. In this example, before the injecting the cooled water with the supplemental agent, the convective heat transfer coefficient may not satisfy the threshold convective heat transfer coefficient, and after the injecting the cooled water with the supplemental agent, the convective heat transfer coefficient may satisfy the threshold convective heat transfer coefficient.

### Example Computer System

Various embodiments of this disclosure may be implemented, for example, using one or more computer systems, such as computer system 900 shown in FIG. 9. For example, the systems, devices, components, and/or structures disclosed herein may be implemented using combinations or sub-combinations of computer system 900. Additionally or alternatively, computer system 900 can include one or more computer systems that may be used, for example, to implement any of the embodiments discussed herein, as well as combinations and sub-combinations thereof. It is noted, however, that the computer system 900 is provided solely for illustrative purposes, and is not limiting. Embodiments of this disclosure may be implemented using and/or may be part of environments different from and/or in addition to the computer system 900, as will be appreciated by persons skilled in the relevant art(s) based on the teachings contained herein. An example of the computer system 900 shall now be described.

Computer system 900 may include one or more processors (also called central processing units, or CPUs), such as one or more processors 904. In some embodiments, one or more processors 904 may be connected to a communications infrastructure 906 (e.g., a bus).

Computer system 900 may also include user input/output device(s) 903, such as monitors, keyboards, pointing devices, etc., which may communicate with communications infrastructure 900 through user input/output interface(s) 902.

One or more of the one or more processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, and other suitable applications.

Computer system 900 may also include a main memory 908 (e.g., a primary memory or storage device), such as random access memory (RAM). Main memory 908 may include one or more levels of cache. Main memory 908 may have stored therein control logic (e.g., computer software) and/or data.

Computer system 900 may also include one Of more secondary storage devices or memories such as secondary memory 910. Secondary memory 910 may include, for example, a hard disk drive 912, a removable storage drive 914 (e.g., a removable storage device), or both. Removable storage drive 914 may be a floppy disk drive, a magnetic tape drive, a compact disk drive, an optical storage device, tape backup device, and/or any other storage device/drive.

Removable storage drive 914 may interact with a removable storage unit 918.

Removable storage, unit 918 may include a computer usable or readable storage device having stored thereon computer software (e.g., control logic) and/or data. Removable storage unit 918 may be a floppy disk, magnetic tape, compact disk, DVD, optical storage disk, and; any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such, as that found in video game devices), a removable memory chip (such as an EPROM or PROM) and associated socket, a memory stick and USB or other port, a memory card and associated memory card slot, and/or any other removable storage unit and associated interface.

Computer system 900 may further include a communications interface 924 (e.g., a network interface). Communications interface 924 may enable computer system 900 to communicate and interact with any combination of external devices, external networks, external entities, etc. (individually and collectively referenced by reference number 928). For example, communications interface 924 may allow computer system 900 to communicate with external devices 928 (e.g., remote devices) over communications path 926, which may be wired and/or wireless (or a combination thereof), and which may include any combination of LANs, WANs, the Internet, etc. Control logic and/or data may be transmitted to and from computer system 900 via communications path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, tile formats, and schemas in computer system 900 may be derived from standards including but not limited to JavaScript Object Notation (JSON), Extensible Markup Language (XML), Yet Another Markup Language (YAML), Extensible Hypertext Markup Language (XHIML), Wireless Markup Language (WML), MessagePack, XML User Interface Language (XUL), or any other functionally similar representations alone or in combination. Alternatively, proprietary data structures, formats or schemas may be used, either exclusively or in combination with various standards.

In some embodiments, a tangible, non-transitory apparatus or article of manufacture including a tangible, non-transitory computer useable or readable medium having control logic (software) stored thereon may also be referred to herein as a computer program product or program storage device. This includes, but is not limited to, computer system 900, main memory 908, secondary memory 910, removable storage unit 918, and removable storage unit 922, as well as tangible articles of manufacture embodying any combination of the foregoing. Such control logic, when executed by one or more data processing devices (e.g., one or more computing devices, such as the computer system 900 or the one or more processors 904), may cause such data processing devices to operate as described herein.

Based on the teachings contained in this disclosure, it will be apparent to persons skilled in the relevant arts) how to make and use embodiments of this disclosure using data processing devices, computer systems and/or computer architectures other than that shown in FIG. 9. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all example embodiments as contemplated by the inventors, and thus, are not intended to limit this disclosure or the appended claims in any way.

While this disclosure describes example embodiments for example fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been defined herein fore the convenience of the description. Alternate boundaries can be defined as long as the specified functions and relationships (or equivalents thereof) are appropriately performed. Additionally, alternative embodiments can perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct, contact with each other, but yet still co-operate or interact with each other.

The breadth and scope of this disclosure should not be limited by any of the above-described example embodiments, but should be defined only in accordance with the following claims and their equivalents.

What is claimed is:

1. A method comprising:
pumping, via an extraction well, heated water from an extraction depth of a hot sedimentary aquifer (HSA);
extracting, via a power generation, unit, heat from the heated water to generate power and transform the heated water into cooled water; and
injecting, via an injection well, the cooled water at an injection depth of the HSA,
wherein a convective heat transfer coefficient of the HSA satisfies a threshold convective heat transfer coefficient.

2. The method of claim 1, further comprising:
stimulating a convective flow field within the HSA based on the pumping the heated water from the extraction depth and the injecting the cooled water at the injection depth,
wherein the convective flow field satisfies a threshold convective heat transfer rate that provides a convective thermal recharge of the extracted heat.

3. The method of claim 1, wherein the pumping the heated water comprises pumping, via the extraction well, the heated water from the extraction depth at an extraction rate that stimulates a convective flow field, and wherein the injecting the cooled water comprises injecting, via the injection well, the cooled water at the injection depth at an injection rate that stimulates the convective flow field.

4. The method of claim 1, wherein a convective heat transfer within the HSA is indicative of a gravity-driven convective flow of water through the HSA induced by a gravitational field within the HSA.

5. The method of claim 4, wherein:
the extraction well comprises an extraction lateral disposed within a first region of the HSA;
the injection well comprises an injection lateral disposed within a second region of the HSA; and
a depth difference between the extraction lateral and the injection lateral is equal to or greater than a threshold depth difference that satisfies, based on the gravity-driven convective flow of the water through the HSA, a threshold convective heat transfer rate that provides a convective thermal recharge of the extracted heat.

6. The method of claim 1, wherein a convective heat transfer within the HSA is indicative of a pressure-driven convective flow of water through the HSA induced by a natural pressure gradient within the HSA.

7. The method of claim 6, wherein the natural pressure gradient is equal to or greater than a threshold natural pressure gradient that satisfies, based on the pressure-driven convective flow of the water through the HSA, a threshold convective heat transfer rate that provides a convective thermal recharge of the extracted heat.

8. The method of claim 1, wherein a convective heat transfer within the HSA is indicative of a convective flow of water through the HSA induced by a dipolar pressure gradient formed within the HSA based on the pumping the heated water from the extraction depth and the injecting the cooled water at the injection depth.

9. The method of claim 8, wherein the dipolar pressure gradient is equal to or greater than a threshold dipolar pressure gradient that satisfies, based on the convective flow of the water through the HSA, a threshold convective heat transfer rate that provides a convective thermal recharge of the extracted heat.

10. The method of claim 1, wherein a convective heat transfer within the HSA is indicative of a temperature-driven convective flow of water through the HSA induced by a temperature gradient formed within the HSA based on the pumping the heated water from the extraction depth and the injecting the cooled water at the injection depth.

11. The method of claim 10, wherein the temperature gradient is equal to or greater than a threshold temperature gradient that satisfies, based on the temperature-driven convective flow of the water through the HSA, a threshold convective heat transfer rate that provides a convective thermal recharge of the extracted heat.

12. The method of claim 1, wherein the convective heat transfer comprises a multi-mode heat transfer within the HSA indicative of two or more of:
a gravity-driven convective flow of water through the HSA induced by a gravitational field within the HSA;
a pressure-driven convective flow of water through the HSA induced by a natural pressure gradient within the HSA;
a convective flow of water through the HSA induced by a dipolar pressure gradient formed within the HSA based on the pumping the heated water from the extraction depth and the injecting the cooled water at the injection depth; and
a temperature-driven convective flow of water through the HSA induced by a temperature gradient formed within the HSA based on the pumping the heated water from the extraction depth and the injecting the cooled water at the injection depth.

13. A method comprising:
identifying a hot sedimentary aquifer (HSA) below a surface location and having a convective heat transfer coefficient hat satisfies a threshold convective heat transfer coefficient;
determining, based on a geothermal characteristic of the HSA that satisfies a threshold associated with providing geothermal energy, an extraction depth for an extraction well disposed to extract heated water from the HSA and an injection depth for an injection well disposed to inject cooled water into the HSA that is generated from a heat extraction process associated with capturing the geothermal energy;
configuring a geothermal system in association with the surface location to extract the heated water from the HSA at the extraction depth; and
configuring the geothermal system to inject the cooled water into the HSA at the injection depth.

14. The method of claim 13, further comprising:
configuring the geothermal system to stimulate a convective flow field within the HSA based on an extraction of the heated water from the HSA at the extraction depth and an injection of the cooled water into the HSA at the injection depth,
wherein the convective flow field satisfies a threshold convective heat transfer rate that provides a convective thermal recharge of the extracted heat.

15. The method of claim 13, wherein:
the configuring the geothermal system to extract the heated water comprises configuring the geothermal system to extract, via the extraction well, the heated water from the HSA at the extraction depth at an extraction rate that stimulates a convective flow field; and
the configuring the geothermal system to inject the cooled water comprises configuring the geothermal system to inject, via the injection well, the cooled water into the HSA at the injection depth at an injection rate that stimulates the convective flow field.

16. The method of claim 13, wherein a convective heat transfer within the HSA is indicative of a gravity-driven convective flow of water through the HSA induced by a gravitational field within the HSA.

17. The method of claim 16, wherein:
the extraction well comprises an extraction lateral disposed within a first region of the HSA;
the injection well comprises an injection latera disposed within a second region of the HSA; and
a depth difference between the extraction lateral and the injection lateral is equal to or greater than a threshold depth difference that satisfies, based on the gravity-driven convective flow of the water through the HSA, a threshold convective heat transfer rate that provides a convective thermal recharge of the extracted heat.

18. The method of claim 13, wherein a convective heat transfer within the HSA is indicative of a pressure-driven convective flow of water through the HSA induced by a natural pressure gradient within the HSA.

19. The method of claim 18, wherein the natural pressure gradient is equal to or greater than a threshold natural pressure gradient that satisfies, based on the pressure-driven convective flow of the water through the HSA, a threshold convective heat transfer rate that provides a convective thermal recharge of the extracted heat.

20. The method of claim 13, wherein a convective heat transfer within the HSA is indicative of a convective flow of water through the HSA induced by a dipolar pressure gradient formed within the HSA based on an extraction of the heated water from the HSA at the extraction depth and an injection of the cooled water into the HSA at the injection depth.

21. The method of claim 20, wherein the dipolar pressure gradient is equal to or greater than a threshold dipolar pressure gradient that satisfies, based on the convective flow of the water through the HSA, a threshold convective heat transfer rate that provides a convective thermal recharge of the extracted heat.

22. The method of claim 13, wherein a convective heat transfer within the HSA is indicative of a temperature-driven convective how of water through the HSA induced by a temperature gradient formed within the HSA based on an extraction of the heated water from the HSA at the extraction depth and an injection of the cooled water into the HSA at the injection depth.

23. The method of claim 22, wherein the temperature gradient is equal to or greater than a threshold temperature gradient that satisfies, based on the temperature-driven convective flow of the water through the HSA, a threshold convective heat transfer rate that provides a convective thermal recharge of the extracted heat.

24. The method of claim 22, wherein the convective heat transfer comprises a multi-mode heat transfer within the HSA indicative of two or more of:
a gravity -driven convective flow of water through the HSA induced by a gravitational field within the HSA;
a pressure-driven convective flow of water through the HSA induced by a natural pressure gradient within the HSA;
a convective flow of water through the HSA induced by a dipolar pressure gradient formed within the HSA based on an extraction of the heated water from the HSA at the extraction depth and an injection of the cooled water into the HSA at the injection depth; and
a temperature-driven convective flow of water through the HSA induced by a temperature gradient formed within the HSA based on the extraction of the heated water from the HSA at the extraction depth and the injection of the cooled water into the HSA at the injection depth.

25. A geothermal system comprising;
a power generation unit;
a pump system;
a well system disposed within a hot sedimentary aquifer (HSA), wherein a convective heat transfer coefficient of the HSA satisfies a threshold convective heat transfer coefficient, and wherein the well system comprises:
an extraction well that enables the pump system to provide heated water at an extraction depth of the HSA to the power generation unit, and
an injection well that enables the pump system to inject cooled water from the power generation unit into the HSA at an injection depth; and
a regulatory device configured to:
generate a first control signal configured to instruct the pump system to pump, via the extraction well, the heated water from the HSA at the extraction depth to the power generation unit;
generate a second control signal configured to instruct the power generation unit to extract heat from the heated water to generate power and transform the heated water into the cooled water; and
generate a third control signal configured to instruct the pump system to pump, via the injection well, the cooled water from the power generation unit into the HSA at the injection depth.

26. The geothermal system of claim 25, wherein the well system is configured to stimulate a convective flow field within the HSA based on a first pumping of the heated water from the HSA at the extraction depth responsive to the first control signal and further based on a second pumping of the cooled water into the HSA at the injection depth responsive to, the third control signal, and wherein the convective flow field satisfies a threshold convective heat transfer rate that provides a convective thermal recharge of the extracted heat.

27. The geothermal system of claim 25, wherein:
the first control signal is further configured to instruct the pump system to pump, via the extraction well, the heated water from the HSA, at the extraction depth at an extraction rate that stimulates a convective flow field; and
the third control signal is further configured to instruct the pump system to pump, via the injection well, the cooled water into the HSA at the injection depth at an injection rate that stimulates the convective flow field.

28. The geothermal, system of claim 25. wherein a convective heat transfer within the HSA is indicative of a gravity-driven convective flow of water through the HSA induced by a gravitational field within the HSA.

29. The geothermal system of claim 27, wherein:
the extraction well comprises an extraction lateral disposed within a first region of the HSA;
the injection well comprises an injection lateral disposed within a second region of the HSA; and
a depth difference between the extraction lateral and the injection lateral is equal to or greater than a threshold depth difference that satisfies, based on the gravity-driven convective flow of the water through the HSA, a threshold convective heat transfer rate that provides a convective thermal recharge of the extracted heat.

30. The geothermal system of claim 25, wherein, a convective heat transfer within the HSA is indicative of a pressure-driven convective flow of water through the HSA induced by a natural pressure gradient within the HSA.

31. The geothermal system of claim 30, wherein the natural pressure gradient is equal to or greater than a threshold natural pressure gradient that satisfies, based on the pressure-driven convective flow of the water through the HSA, a threshold convective heat transfer rate that provides a convective thermal recharge of the extracted heat.

32. The geothermal system of claim 25, wherein a convective heat transfer within the HSA is indicative of a convective flow of water through the HSA induced, by a dipolar pressure gradient formed within the HSA based on an extraction of the heated water from the HSA at the extraction depth and an injection of the cooled water into the HSA at the injection depth.

33. The geothermal system of claim 32, wherein the dipolar pressure gradient is equal to or greater than a threshold dipolar pressure gradient that satisfies, based on the convective flow of the water through the HSA, a threshold convective heat transfer rate that provides a convective thermal recharge of the extracted heat.

34. The geothermal system of claim 25. wherein a convective heat transfer within the HSA is indicative of a temperature-driven convective flow of water through the HSA induced by a temperature gradient firmed within the HSA based on an extraction of the heated water from the HSA at the extraction depth and an injection of the cooled water into the HSA at the injection depth.

35. The geothermal system of claim 34, wherein the temperature gradient is equal to or greater than a threshold temperature gradient that satisfies, based on the temperature-driven convective flow of the water through the HSA, a threshold convective heat transfer rate that provides a convective thermal recharge of the extracted heat.

36. The geothermal system of claim 25, wherein the convective heat transfer comprises a multi-mode heat transfer within the HSA indicative of two or more of:
a gravity-driven convective flow of water through the HSA induced by a gravitational field within the HSA;
a pressure-driven convective flow of water through the HSA induced by a natural pressure gradient within the HSA;
a convective flow of water through the HSA induced by a dipolar pressure gradient formed within the HSA based on an extraction of the heated water from the HSA at the extraction depth and an injection of the cooled water into the HSA at the injection depth; and
a temperature-driven convective flow of water through the HSA induced by a temperature gradient formed within the HSA based on the extraction of the heated water from the HSA at the extraction depth and the injection of the cooled water into the HSA at the injection depth.
